(19) United States
(12) Patent Application Publication
(10) Pub. No.: US 2018/0240359 A1
(43) Pub. Date: Aug. 23, 2018

(54) Biochmical and nutritional application platform

(71) Applicant: NutriCern, Inc., Sebastopol, CA (US)

(72) Inventor: Jonathan Todd Hujsak, Ramona, CA (US)

(21) Appl. No.: 15/932,336

(22) Filed: Feb. 16, 2018

Related U.S. Application Data
(60) Provisional application No. 62/460,578, filed on Feb. 17, 2017.
(60) Provisional application No. 62/512,819, filed on May 31, 2017.

(51) Int. Cl. G09B 19/00; G06N 5/02; G06F 17/30; G06N 99/00

(52) U.S. Cl. CPC G09B 19/0092; G06N 5/02; G09B 5/02; G06N 99/005; G06F 17/30477

(57) ABSTRACT

A biochemical and nutritional application platform combines nutritional, biochemical, physiological, botanical, medical, culinary, and many other forms of knowledge with an intelligent decision support capability to provide consumers with nutritional guidance in an efficient and useful manner. The biochemical and nutritional application platform is designed to support an environment of applications for food consumption design, dietary planning, nutraceutical research, pharmaceutical research, nutritional counseling, cosmeceutical development, academic learning, agricultural research, and many other domains that can take advantage of real-time guidance from deep biochemical and molecular nutrition knowledge.

### CROSS-REFERENCE TO RELATED APPLICATIONS

This application claims the benefit of and priority to U.S. Provisional Application No. 62/460,578, filed on Feb. 17, 2017, and U.S. Provisional Application No. 62/512,819, filed on May 31, 2017, all of which are hereby incorporated by reference in their entirety.

### BACKGROUND

This invention relates generally to nutrition, and more particularly to providing nutritional guidance using a biochemical and nutritional application platform.

Often times, it is advantageous for consumers of food to design their diets to align with their wellness and/or health objectives. For example, an individual may have one or more diseases that the individual wishes to prevent, and in some cases may also have genetic predisposition for a specific disease. As another example, an individual may already be suffering from a disease, and may wish to alleviate or cure the disease. As yet another example, an individual may be interested in improving physiological and psychological performance in areas such as visual acuity, cognitive functions, memory, and physical endurance. Alternatively, the diet may have to take into account groups as opposed to single individuals. For example, a family meal may be designed to balance the needs of all family members. As another example, a sports training team may design a diet that enhances the physical endurance of the whole team. As yet another example, a hospital may design meals that are delivered to patients to mitigate different aspects of a metabolic syndrome.

Typically, foods contain various types of chemicals and nutrients that generate a multitude of physiological and pharmacological actions related to consumers' wellness and health goals. Designing a food consumption plan around wellness and health objectives has the potential to significantly reduce health care costs, and may be an alternative and supplementary approach to treating diseases, signs, and symptoms that can potentially reduce or eliminate the need for expensive conventional medical treatments as well as pharmaceuticals. More importantly, it has significant preventive potential, in some cases preventing disease from manifesting in the first place.

However, it is often difficult for consumers to plan meals directed to their wellness and/or health objectives because determining the aggregate physiological and pharmacological actions associated with food is a complicated problem, and there is a lack of resources to do so accurately and effectively. For example, for a salad with just a few types of vegetables, fruits, seeds, and nuts, each ingredient may have a hundred or more macro-nutrients (e.g., protein, carbohydrates, fats, water), micro-nutrients (e.g., vitamins, minerals, trace elements), and phytonutrients (e.g., various chemicals found in plants). Each nutrient can have a hundred or more known pharmacological actions, such as “anti-hypertensive” or “anti-inflammatory” actions, that interact with humans at the cellular level, modulating cellular metabolic, signaling, and gene expression pathways. Complicating matters even more, nutrients from different foods may interfere with each other when the foods are mixed or consumed together. For example, nutrients in different foods may reinforce each other's pharmacological actions. In other cases, the nutrients may cancel each other's pharmacological actions out.

Even if such information on the effects of food is available, most existing information retrieval systems typically return a collection of documents and webpages that each contain scattered portions of information relevant to consumers. For example, one page may contain information on the potential allergies triggered by an ingredient of the salad, and another page may contain information on how the ingredient can interfere with a prescribed drug. In such an environment, it is largely the consumer that is responsible for integrating the information into a meaningful conclusion about the physiological actions of the ingredient. Working out the net pharmacological effect of even a simple salad with a few ingredients may be a time consuming and difficult problem, even for an individual who has the requisite nutritional, medical, and biochemical knowledge. And it may not be possible still to get a complete picture of the actual pharmacological effect. Moreover, the consumer may further be discouraged to design a healthy food consumption plan because the information does not take into account the consumer's own preferences for food. For example, although kale may be highly beneficial for the health of a consumer, the individual may not include it in his or her food consumption plan because it is unpalatable to the individual.

Rather than a system in which consumers have to learn complex new knowledge, there is a need for a system in which knowledge on nutrition, food, and culinary practices is delivered to the consumer in an appealing, diverse, and customized way such that consumers can quickly make decisions on dietary nutrition that are beneficial to them.

### SUMMARY

A biochemical and nutritional application platform combines nutritional, biochemical, physiological, botanical, medical, culinary, and many other forms of knowledge with an intelligent decision support capability to provide consumers with nutritional guidance in an efficient and useful manner. The biochemical and nutritional application platform is designed to support an environment of applications for food consumption design, dietary planning, nutraceutical research, pharmaceutical research, nutritional counseling, cosmeceutical development, academic learning, agricultural research, and many other domains that can take advantage of real-time guidance from deep biochemical and molecular nutrition knowledge.

Specifically, the application platform includes a core knowledge database that indicates relationships between various nutrition-related topics, such as foods, chemicals, pharmacological actions of chemicals, and biological conditions of consumers to each other through a plurality of knowledge databases. For example, the knowledge database may indicate which ingredients are present in carrots, and the pharmacological actions that these ingredients have on organs, such as the liver, of consumers. As another example, the knowledge database may indicate which nutritional ingredients are beneficial for alleviating a particular set of diseases or symptoms. As yet another example, the knowledge database may indicate which foods are from similar geographic areas.

In one embodiment, the knowledge database is an ontology database that includes a plurality of ontology data structures corresponding to a plurality of topics related to nutrition. For example, the knowledge database may include a food ontology, a nutrition ontology, a phytochemicals ontology, a disease ontology, and the like. Each ontology data structure includes a plurality of nodes assigned to the corresponding topic. For example, the phytochemicals ontology may include a plurality of nodes each indicating a phytochemical that is found in plants. The knowledge database also includes a plurality of semantic links, in which each semantic link represents a relationship between two nodes. The semantic links may connect nodes from two different ontology structures, and may indicate relationships such as “alleviates,” “causes,” “aggravates,” or “prevents” between the specific nodes. For example, the node corresponding to carrots in the food ontology would have a “prevents” semantic relationship with multiple carcinoma nodes in the disease ontology.

In addition to the knowledge database, the application platform also includes one or more reasoning and decision support components that perform services such as navigation through the knowledge database, classification, reasoning, and machine-learning services that make use of information contained in the knowledge database to provide guidance on food design, dietary planning, and the like. For example, the application platform may navigate through the knowledge database to identify foods that have similar pharmacological actions as carrots. Access to the knowledge database and the services of the application platform may be provided through external interfaces such as application programming interfaces (API).

In one embodiment, the architecture of the application platform is centered around semantic middleware that ties the knowledge database, reasoning and decision support components, and external interfaces of the application platform together. The application platform supports and deploys one or more applications that provide various types of nutritional guidance with the support of the knowledge database and the reasoning and decision support services of the application platform. For example, the external interfaces of the application platform may include an application API that allows software applications to be designed around and access the resources of the application platform through local or remote access to the application platform.

In one instance, an application receives a query and identifies information relevant to the query to provide nutritional guidance. For example, responsive to a query for similar ingredients to carrots, the application platform may perform inference based on the semantic links of the knowledge database, and provide foods that trigger similar pharmacological actions as carrots to the application. The application can provide the user with the identified foods such that the user can substitute the identified foods in meals instead of carrots.

In another instance, an application aids in the discovery process of new foods and ingredients that may potentially have desired pharmacological actions. For example, given a food (e.g., carrot) with a desired pharmacological action (e.g., cancer prevention), the application platform can map the food back to its specific plant species. Given the plant species, the knowledge discovery service can discover similar plants based on taxonomic classifications, similar plant physiology, similar geospatial regions, similar growth habits, or similar biochemistry to identify plants that could potentially have the desired pharmacological action. The application can provide the identified plants to the user such that the identified plants can be used as potential ingredients in foods.

In yet another instance, an application allows design of foods at the molecular level with regards to modulating particular cellular pathways for the prevention or treatment of diseases, signs, symptoms, or injuries. The application may also allow design of foods at the cellular level for physiological enhancements such as enhanced agility, improved stamina, enhanced cognition, improved vision, or counter-aging. For example, military food designers may use the application to design foods that improve physiological or psychological performance of soldiers in the field. As another example, a food company may use the application to design foods that are more nutritionally beneficial for consumers.

In yet another instance, an application provides analysis of existing foods to determine their net impact at the cellular level relative to diseases, signs, symptoms, injuries, as well as from the perspective of desired physiological enhancements. For example, a government organization may use the application to identify foods that contain unsafe ingredients for food safety regulation purposes. As another example, general consumers may use the application platform to avoid potential allergens, sensitivities, carcinogens, or toxic substances in processed foods.

In yet another instance, an application provides a consumption plan that adjusts the timing of nutrients to avoid opposing actions between nutrients, or in other cases, to reinforce specific actions between nutrients. The application platform may accomplish planning at the macroscopic level by planning recipes and meals based on their ingredients, constituent nutrients, nutrient concentrations, and metabolism of consumers. The application platform can also adjust timing of nutrient ingestions during the day to support upregulation or downregulation of specific cellular activities for a variety of objectives such as increasing physical activity, improving sleep, or enhancing cognitive performance. As an example, the application provide a dietary plan temporally adjusted to expose nutrients to a patient at times that would maximize the benefits in the diet

In yet another instance, an application adjusts food consumption plans to account for context-specific eating behaviors. The context-specific eating behaviors can be found through histories of consumer eating patterns and consumer profile data. For example, during a recreational activity such as watching football, consumers with a specific profile type and cultural background may be predisposed to consume certain food types based on taste, texture, or other factors. The application can recommend food designs that are appealing in such context-specific environments, and yet are also designed for the consumers' unique nutritional requirements based on their personal profiles.

The application platform can also provide services to external information systems without the need for separate applications. For example, the external interfaces of the application platform may include a business-to-business (B2B) gateway API that allows interoperability with an external enterprise system. The external information system is in this case a direct consumer of low-level services of the application platform. For example, a wellness portal hosted by a major insurance enterprise can gain access to the knowledge database and directly incorporate the reasoning and decision support services of the application platform without an intervening application layer. Instead, the imported services would be wrapped for delivery through an existing enterprise application or user portal.

The application platform can also federate with large-scale external knowledge repositories and databases where the resources are not static and are very large in extent. Specifically, the external interfaces of the application platform allow interoperability and information sharing between the application platform and the external knowledge repositories such that the application platform can gain access to the knowledge repositories without the cost of importing and maintaining such completed collections.

### BRIEF DESCRIPTION OF THE DRAWINGS

FIG. 1 is a high level block diagram of a system environment for a nutritional application platform, according to an embodiment.

FIG. 2 is an example knowledge database used to provide nutritional guidance by the nutritional application platform, according to an embodiment.

FIG. 3 is an example architecture of the nutritional application platform, according to one embodiment.

FIG. 4 is a block diagram of an architecture of a nutritional application platform, according to an embodiment.

FIG. 5 is an example illustration of a knowledge database, according to an embodiment.

FIG. 6A illustrates an example phytonutrients ontology data structure, according to an embodiment. FIG. 6B illustrates an example foods ontology data structure, according to an embodiment. FIG. 6C illustrates an example plants ontology data structure, according to an embodiment.

FIG. 7A illustrates a plurality of example inter semantic links between ontology data structures, according to an embodiment. FIG. 7B illustrates a plurality of example inter semantic links between ontology data structures, according to another embodiment. FIG. 7C illustrates a plurality of example inter semantic links for a phytonutrients ontology, according to another embodiment. FIG. 7D illustrates a plurality of example inter semantic links for a foods ontology, according to another embodiment.

FIG. 8 illustrates an example process for graph-based reasoning based on a sub-graph of nodes identified in the knowledge database, according to an embodiment.

FIG. 9 illustrates an example process of recommending and re-planning a wellness plan for a consumer based on a machine-learned behavioral model, according to an embodiment.

FIG. 10A is an example graphical user interface for presenting phytochemicals contained in carrots, according to an embodiment. FIG. 10B is an example graphical user interface for presenting a filtered set of phytochemicals contained in carrots, according to an embodiment. FIG. 10C is an example graphical user interface for presenting aggregate caloric ratios between carbohydrates, fats, and protein for multiple diets, according to an embodiment.

FIGS. 11A-11K illustrate example user interfaces of an application supported by the nutritional application platform, according to another embodiment.

FIG. 12A illustrates an example architecture for a concussion application, according to one embodiment. FIG. 12B illustrates a detailed view of the platform of the concussion application, according to one embodiment. FIG. 12C illustrates details of user information received by the interface of the concussion application and operation of the pre-concussion phase of the application, according to one embodiment. FIG. 12D illustrates details of operation of the concussion application during the pre-concussion phase and operation of the concussion application during the post-concussion phase, according to an embodiment. FIG. 12E illustrates details of the operation of the concussion application during the post-concussion phase, according to an embodiment. FIG. 12F illustrates example API's for clients of the concussion application, according to an embodiment.

FIG. 13 illustrates a flowchart for providing nutritional guidance to a user, according to an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

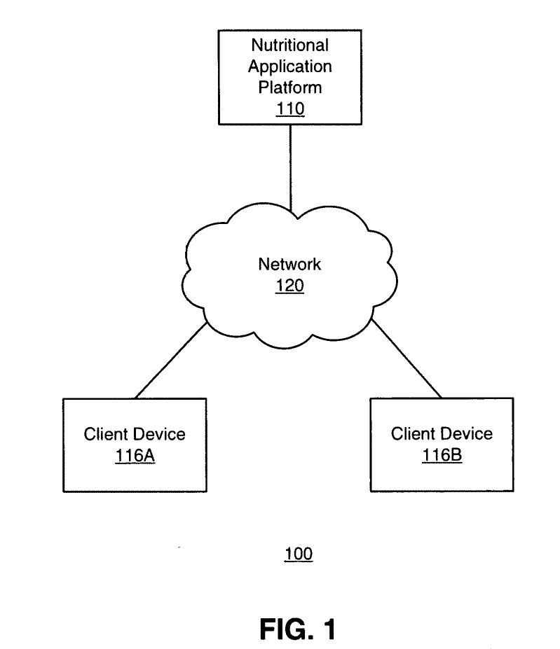

FIG. 1 is a high level block diagram of a system environment for a nutritional application platform 110, according to an embodiment. The system environment 100 shown by FIG. 1 includes one or more client devices 116A and 116B, a network 120, and a nutritional application platform 110. In alternative configurations, different and/or additional components may be included in the system environment 100.

The nutritional application platform 110 is a system that combines nutritional, biochemical, physiological, botanical, medical, culinary, and many other forms of knowledge with an intelligent decision support capability to provide users of client devices 116 with nutritional guidance in an efficient and useful manner. The nutritional application platform 110 is designed to support an environment of applications for food consumption design, dietary planning, nutraceutical research, pharmaceutical research, nutritional counseling, cosmeceutical development, academic learning, agricultural research, and many other domains that can take advantage of real-time guidance from deep biochemical and molecular nutrition knowledge.

Specifically, the application platform 110 includes a core knowledge database that indicates relationships between various nutrition-related topics, such as foods, chemicals, pharmacological actions of chemicals, and biological conditions of consumers to each other through a plurality of databases. For example, the knowledge database may indicate which ingredients are present in carrots, and the pharmacological actions that these ingredients have on organs, such as the liver, of consumers. As another example, the knowledge database may indicate which nutritional ingredients are beneficial for alleviating a particular set of diseases or symptoms. As yet another example, the knowledge database may indicate which foods are from similar geographic areas.

In one embodiment, the knowledge database is an ontology database that includes a plurality of ontology data structures corresponding to a plurality of topics related to nutrition. For example, the knowledge database may include a food ontology, a nutrition ontology, a phytochemicals ontology, a disease ontology, and the like. Each ontology data structure includes a plurality of nodes assigned to the corresponding topic. For example, the phytochemicals ontology may include a plurality of nodes each indicating a phytochemical that is found in plants. The knowledge database also includes a plurality of semantic links, in which each semantic link represents a relationship between two nodes. The semantic links may connect nodes from two different ontology structures, and may indicate relationships such as “alleviates,” “causes,” “aggravates,” or “prevents” between the specific nodes. For example, the node corresponding to carrots in the food ontology would have a “prevents” semantic relationship with multiple carcinoma nodes in the disease ontology.

In addition to the knowledge database, the nutritional application platform 110 also includes one or more reasoning and decision support components that perform services such as navigation through the knowledge database, classification, reasoning, and machine-learning services. The reasoning and decision support components make use of information contained in the knowledge database to provide guidance on food design, dietary planning, and the like to users of client devices 116. For example, the nutritional application platform 110 may navigate through the knowledge database to identify foods that have similar pharmacological actions as carrots. Access to the knowledge database and the services of the application platform may be provided through external interfaces such as application programming interfaces (API).

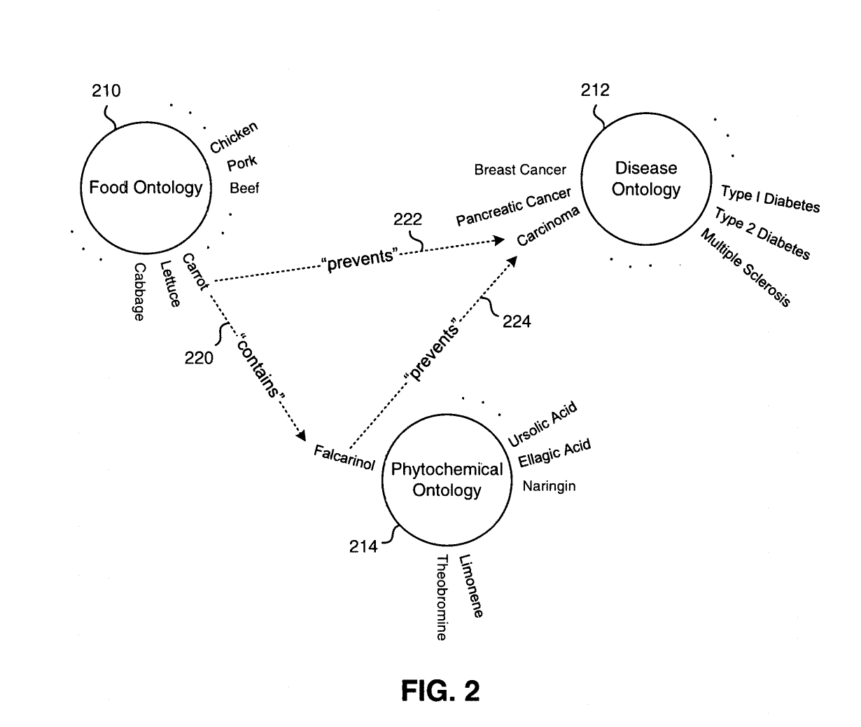

FIG. 2 is an example knowledge database used to provide nutritional guidance by the nutritional application platform 110, according to an embodiment. The knowledge database includes, for example, a food ontology 210, a disease ontology 212, and a phytochemical ontology 214. The food ontology 210 includes nodes such as “chicken,” “pork,” “beef,” “carrots,” “lettuce,” and “cabbage,” along with other types of foods. The disease ontology 212 includes nodes such as “breast cancer,” “pancreatic cancer,” “carcinoma,” “type 1 diabetes,” “type 2 diabetes,” and “multiple sclerosis,” along with other types of diseases. The phytochemical ontology 214 includes nodes such as “ursolic acid,” “ellagic acid,” “naringin,” “limonene,” and “theobromine,” along with other types of phytochemicals.

The knowledge database also includes a plurality of semantic links that indicate the relationships between nodes of the ontology data structures. As shown in FIG. 2, the knowledge database includes a semantic link 220 between carrot of the food ontology 210 and falcarinol of the phytochemical ontology 214. The semantic link 220 indicates that carrot contains the phytochemical falcarinol. The knowledge database includes a semantic link 222 between carrot and carcinoma of the disease ontology 212. The semantic link 222 indicates that carrot induces a pharmacological action that prevents carcinoma. The knowledge database includes a semantic link 224 between falcarinol and carcinoma. The semantic link 224 indicates that falcarinol induces a pharmacological action that prevents carcinoma.

Responsive to a request from a user of a client device 116 to provide information on which diseases carrots are beneficial for, the nutritional application platform 110 may navigate through nodes of the ontology data structures to return carcinoma as a response. And the platform 110 may further indicate in the response that carrots contain the phytochemical falcarinol, and that falcarinol induces pharmacological actions that prevent carcinoma.

By organizing the knowledge database into a plurality of ontologies and a plurality of semantic links interconnecting the nodes of the ontologies, the nutritional application platform 110 can navigate through a vast quantity of information in a significantly shorter amount of time than that required to navigate through existing unorganized and separate database structures that must then be combined and interpreted by the user to be useful.

Returning to FIG. 1, in one embodiment, the architecture of the nutritional application platform 110 is centered around semantic middleware that ties the knowledge database, reasoning and decision support components, and external interfaces of the nutritional application platform 110 together. The semantic middleware coordinates requests received through the external interfaces of the nutritional application platform 110 to the appropriate reasoning and decision support components of the application platform 110. The semantic middleware receives responses to the requests and provides them to the external interfaces such that the response can be provided to users of client devices 116.

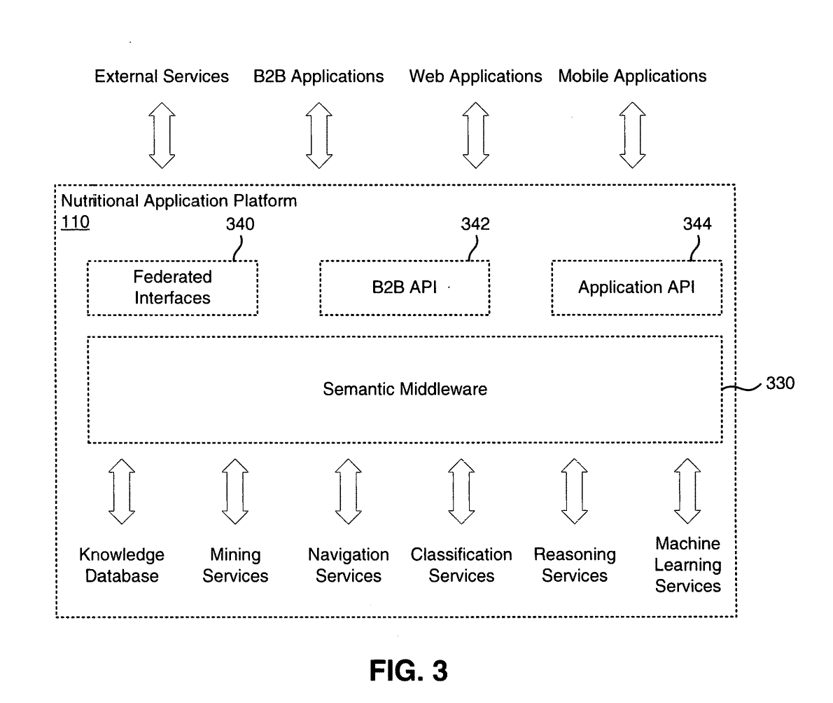

FIG. 3 is an example architecture of the nutritional application platform 110, according to one embodiment. The nutritional application platform 110 shown in FIG. 3 includes the knowledge database and various components that provide reasoning and decision support services. In the embodiment shown in FIG. 3, the services include mining services, navigation services, classification services, reasoning services, and machine learning services. The nutritional application platform 110 also includes semantic middleware 330 that sits on top of the knowledge database and the reasoning and decision support components. The nutritional application platform 110 communicates with external services and applications such as business-to-business (B2B) applications, web applications, and mobile applications through external interfaces. In the embodiment shown in FIG. 3, the external interfaces include federated interfaces 340, B2B API's 342, and application API's 344.

By tying the internal services, the knowledge database, external interfaces, and other components of the nutritional application platform 110, the semantic middleware 330 allows, for example, different services and databases of the application platform 110 to communicate with each other despite differences in input/output data and protocols. The semantic middleware 330 can also help to streamline requests received from various sources, such as from applications built on top of the nutritional application platform 110 or from external API's by coordinating and orchestrating the knowledge database and internal services together to respond to the requests in an efficient manner. This can especially be helpful when the number of requests get significantly large. In addition, the semantic middleware 330 also allows external third-parties to easily build applications utilizing the middleware architecture that allows for easy retrieval of nutritional and biochemical information instead of having the third-parties coordinate the individual services of the nutritional application platform 110 themselves.

Specifically, the nutritional application platform 110 supports and deploys one or more applications that provide various types of nutritional guidance with the support of the knowledge database and the reasoning and decision support components of the application platform 110. For example, software applications, such as web applications and mobile applications, can be designed around the application API 344 that allows the applications to access the resources of the nutritional application platform 110 through local or remote access to the nutritional application platform 110.

In one instance, the nutritional application platform 110 supports an application that receives a query and identifies information relevant to the query to provide nutritional guidance. For example, responsive to a query for similar ingredients to carrots, the nutritional application platform 110 may navigate through an ontology database to identify foods that trigger similar pharmacological actions as carrots, similarly to the example shown in FIG. 2. The application can provide the user with the identified foods such that the user can substitute the identified foods in meals instead of carrots.

In another instance, the nutritional application platform 110 supports an application that aids the discovery of new foods and ingredients that may potentially have desired pharmacological actions. For example, given a food (e.g., carrot) with a desired pharmacological action (e.g., cancer prevention), the nutritional application platform 110 can map the food back to its specific plant species. Given the plant species, the application platform 110 can discover similar plants based on taxonomic classifications, similar plant physiology, similar geospatial regions, similar growth habits, or similar biochemistry to identify plants that could potentially have the desired pharmacological action. The application can provide the identified plants to the user such that the identified plants can be used as potential ingredients in foods.

In yet another instance, the nutritional application platform 110 supports an application that allows design of foods at the molecular level with regards to modulating particular cellular pathways for the prevention or treatment of diseases, signs, symptoms, or injuries. The application may also allow design of foods at the cellular level for physiological enhancements such as enhanced agility, improved stamina, enhanced cognition, improved vision, or counter-aging. For example, military food designers may use the application to design foods that improve physiological or psychological performance of soldiers in the field. As another example, a food company may use the application to design foods that are more nutritionally beneficial for consumers.

In yet another instance, the nutritional application platform 110 supports an application that provides analysis of existing foods to determine their net impact at the cellular level relative to diseases, signs, symptoms, injuries, as well as from the perspective of desired physiological enhancements. For example, a government organization may use the application to identify foods that contain unsafe ingredients for food safety regulation purposes. As another example, general consumers may use the application to avoid potential allergens, carcinogens, or toxic substances in processed foods.

In yet another instance, the nutritional application platform 110 supports an application that provides a consumption plan that adjusts the timing of nutrients to avoid opposing actions between nutrients, or in other cases, to reinforce specific actions between nutrients. The nutritional application platform 110 may accomplish planning at the macroscopic level by planning recipes and meals based on their ingredients, constituent nutrients, nutrient concentrations, and metabolism of consumers. The application platform 110 can also adjust timing of nutrient ingestions during the day to support upregulation or downregulation of specific cellular activities for a variety of objectives such as increasing physical activity, improving sleep, or enhancing cognitive performance. As an example, the application may provide a patient with a dietary plan temporally adjusted to expose nutrients at times that would maximize the benefits.

In yet another instance, the nutritional application platform 110 supports an application that adjusts food consumption plans to account for context-specific eating behaviors. The context-specific eating behaviors can be found through histories of consumer eating patterns and consumer profile data. For example, during a recreational activity such as watching football, consumers with a specific profile type and cultural background may be predisposed to consume certain food types based on taste, texture, or other factors. The application can recommend food designs that are appealing in such context-specific environments, and yet are also designed for the consumers' unique nutritional requirements based on their personal profiles. Machine-learning of eating behavior can also be used to determine the emotional state of users and provide recommendations for food that satisfies emotional eating with healthier choices or that may intentionally alter emotional state.

The nutritional application platform 110 can also provide services to external information systems without the need for separate applications. For example, the services can be designed around the B2B API 342 that allows interoperability with an external enterprise system. The external information system is in this case a direct consumer of low-level services of the nutritional application platform 110. For example, a wellness portal hosted by a major insurance enterprise can gain access to the knowledge database and directly incorporate the reasoning and decision support services of the application platform 110 without an intervening application layer. Instead, the imported services would be wrapped for delivery through an existing enterprise application or user portal.

The nutritional application platform 110 can also federate with large-scale external knowledge repositories and databases where the resources are not static and are very large in extent. Specifically, the external interfaces of the nutritional application platform 110 allow interoperability and information sharing between the application platform 110 and the external knowledge repositories such that the nutritional application platform 110 can gain access to the knowledge repositories without the cost of importing and maintaining such completed collections.

Returning to FIG. 1, the client device 116 is a computing device capable of receiving user input as well as communicating via the network 120. While two client devices 116A, 116B are illustrated in FIG. 1, in practice many client devices 116 may communicate with the systems in environment 100. In one embodiment, a client device 116 is a conventional computer system, such as a desktop or laptop computer. Alternatively, a client device 116 may be a device having computer functionality, such as a personal digital assistant (PDA), a mobile telephone, a smartphone, or another suitable device. A client device 116 is configured to communicate via the network 120.

Users of the online system 110 can interact with the nutritional application platform 110 through client devices 116. In one embodiment, a client device 116 executes applications allowing the user to interact with the nutritional application platform 110. For example, a client device 116 executes a browser application to enable interaction between the client device 116 and the nutritional application platform 110. In another embodiment, a client device 116 interacts with the nutritional application platform 110 through an application programming interface (API) running on a native operating system of the client device 116, such as IOS® or ANDROID™ or cloud-based voice services such as Alexa or Bixby. Specifically, a user of a client device 116 may view or interact with the applications of the nutritional application platform 110 to request nutritional guidance for a food consumption plan of the user.

For example, the users of client devices 116 may be physicians advising patients on risk reduction through nutritional alternatives to conventional medicine. As another example, the users may be nurses and nurse practitioners counseling outpatients on nutrition. As yet another example, the users may be nutritionists providing dietary counseling to patients, consumers, schools, or food services. As a further example, the users may be consumers seeking to meet essential nutrient requirements, prevent or treat disorders, signs or symptoms, or alternatively, achieve particular physiological enhancements. As an additional example, the users may be consumers seeking to avoid allergens, carcinogens, or toxic substances disguised in product packaging by misleading semantics. As yet another example, users may be chefs designing new recipes for restaurants, catering services, or institutional food services. In a further example, users may be insurance executives trying to lower pharmaceutical costs or improve patient outcomes through alternative nutritional treatments. In another example, users may be processed food companies seeking to design more nutritionally optimized foods. In yet another example, users may be grocery executives looking to provide consumers with store-based or in home online or cloud-based voice tools for optimizing nutrition. Furthermore, users may be professional and non-professional athletes interested in physiological performance enhancements, injury alleviation, or injury prevention. Additionally, users may be military food designers seeking to improve physiological and/or psychological performance of soldiers in the field.

In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

### Nutritional Application Platform

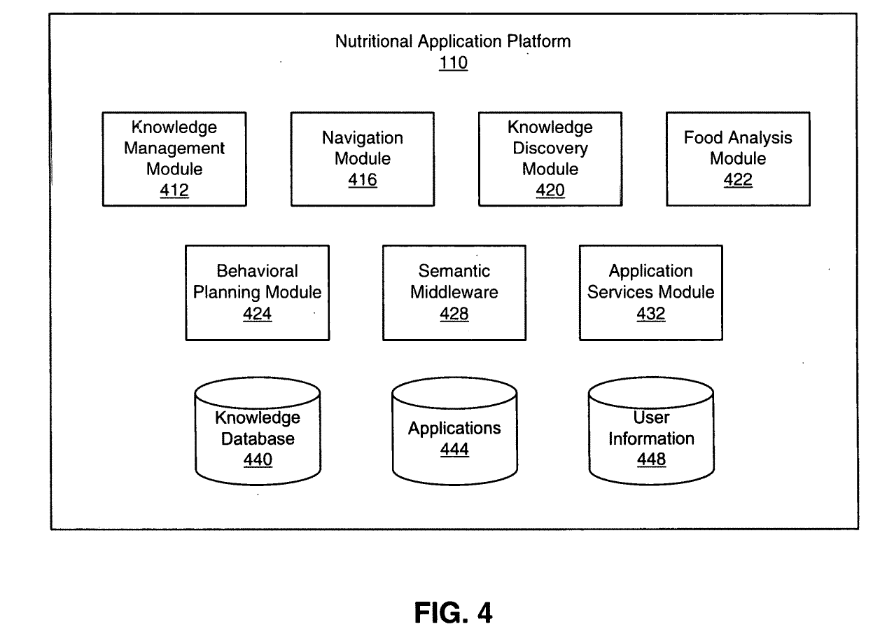

FIG. 4 is a block diagram of an architecture of a nutritional application platform 110, according to an embodiment. The nutritional application platform 110 shown by FIG. 4 includes a knowledge management module 412, a navigation module 416, a knowledge discovery module 420, a behavioral planning module 424, and an application services module 428. The nutritional application platform 110 also includes a data store for a knowledge database 440 and a data store for applications 444.

The knowledge management module 412 manages a knowledge database 440 that contains a plurality of ontology data structures related to nutritional information. Specifically, the plurality of ontology data structures correspond to a plurality of topics. The topics may include, for example, foods, microbiota, plants, animals, fungi, nutrients, phytonutrients, human physiology, culinary, and pharmacological actions, among other things. Relationships between nodes are represented as a plurality of semantic links. Specifically, the semantic links include intra semantic links that are connections between nodes within the same ontology data structure, and inter semantic links that are connections between nodes of different ontology data structures.

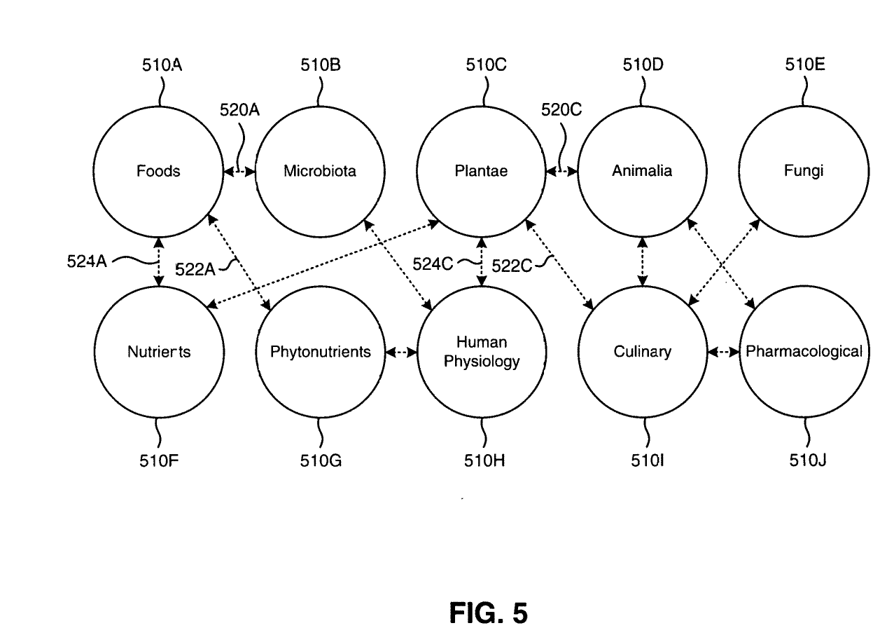

FIG. 5 is an example illustration of a knowledge database 440, according to an embodiment. The example knowledge database 440 shown in FIG. 5 includes ten ontology data structures including a food ontology 510A, a microbiota ontology 510B, a plants ontology 510C, an animals ontology 510D, a fungi ontology 510E, a nutrients ontology 510F, a phytonutrients ontology 510G, a human physiology ontology 510H, a culinary ontology 510I, and a pharmacological actions ontology 510J. As shown in FIG. 5, the food ontology 510A has a plurality of inter semantic links 520A to the microbiota ontology 510B, a plurality of inter semantic links 522A to the phytonutrients ontology 510G, and a plurality of inter semantic links 524A to the nutrients ontology 510F, in addition to a plurality of intra semantic links within its data structure. As another example, the plants ontology 510 has a plurality of semantic links 520C to the animals ontology 510D, a plurality of semantic links 522C to the culinary ontology 510I, and a plurality of semantic links 524C to the human physiology ontology 510H, in addition to a plurality of intra semantic links within its data structure.

Returning to FIG. 4, in one embodiment, the plurality of nodes of an individual ontology data structure are organized into a hierarchical structure, in which one or more child nodes are organized under a corresponding parent node. The concepts represented by child nodes may be variations of the concept represented by the corresponding parent node. The relationship between a parent node and its child nodes may be represented as an intra semantic link “type-of” going from the child node to the parent node. In one instance, the hierarchical structure of the knowledge database may be based on scientific taxonomic structures. For example, a node corresponding to “saturated fatty acids” in the phytochemicals ontology data structure may be connected to “capric acid,” which is one species of a saturated fatty acid through the “type-or” intra semantic link.

In addition, a node of the ontology data structure may be associated with a fact instance that is an instance of the concept represented by the node that contains one or more attributes describing various types of physical characteristics of the concept. The relationship between a node and its fact instance may be represented as an intra semantic link “instance-of” going from the fact instance to the node. For example, the node corresponding to capric acid in the phytochemicals ontology data structure may be connected to its fact instance that contains attributes such as the scientific name, the common name, molar mass, melting point, boiling point, and the like of capric acid.

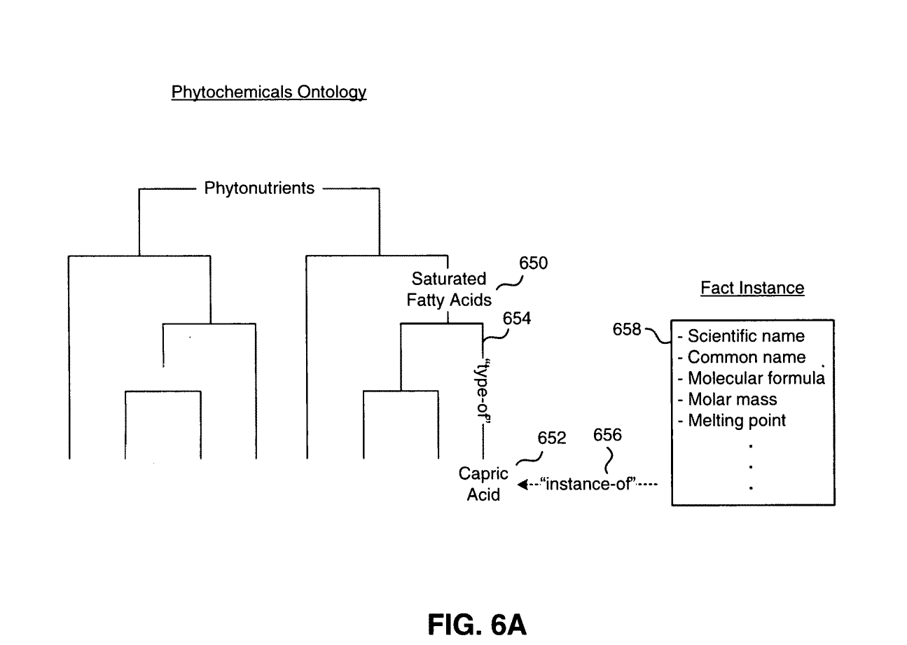

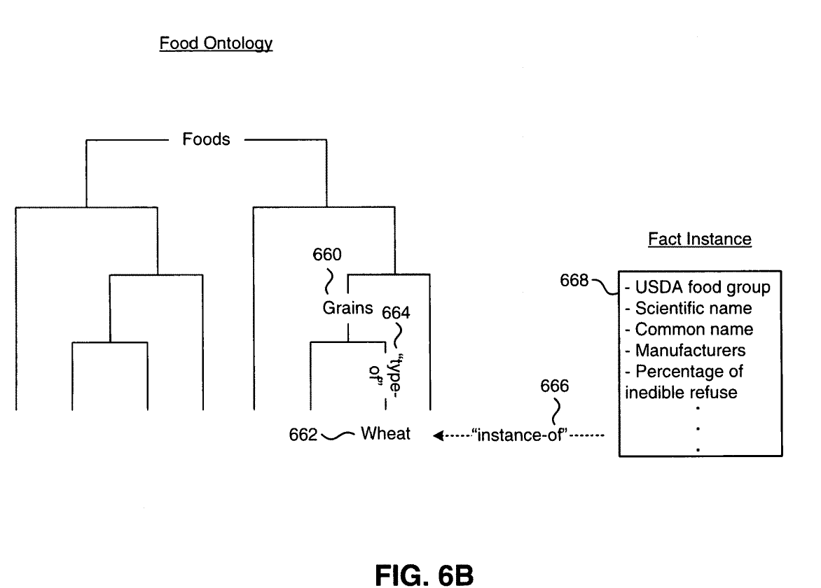

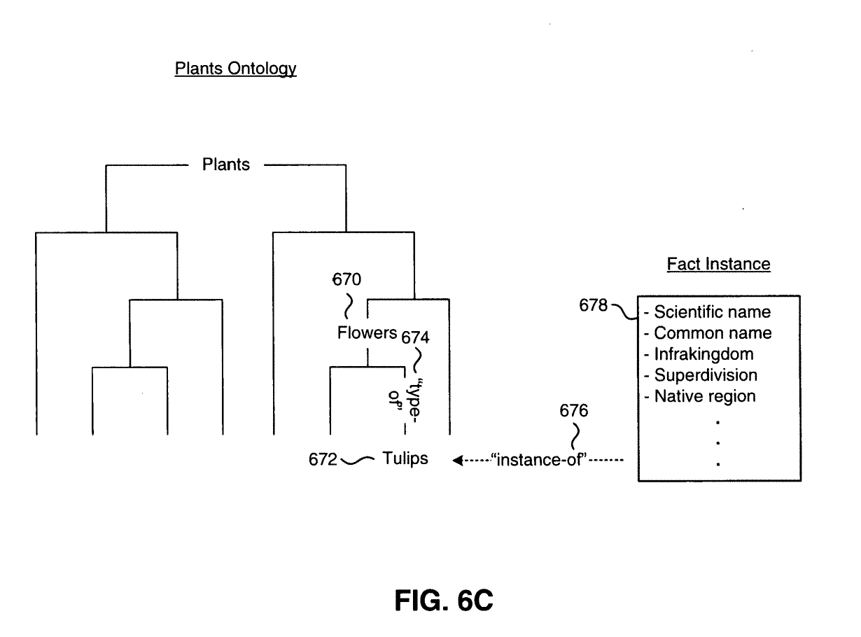

FIG. 6A illustrates an example phytonutrients ontology data structure, according to an embodiment. As shown in FIG. 6A, the phytonutrients ontology data structure includes a plurality of nodes organized in a hierarchical manner. Among others, the plurality of nodes includes a parent node 650 corresponding to saturated fatty acids and a child node 652 corresponding to capric acid that is connected to the node 650 through an intra semantic link 654 “type-of.” The node 652 is associated with a fact instance 658 containing various physical properties of capric acid that is connected to the node 652 through an intra semantic link 656 “instance-of.” Specifically, the fact instance 658 contains scientific name, common name, molecular formula, molar mass, and the melting point of capric acid.

FIG. 6B illustrates an example foods ontology data structure, according to an embodiment. As shown in FIG. 6B, the foods ontology data structure includes a plurality of hierarchical nodes including a parent node 660 corresponding to “grains” and a child node 662 corresponding to “wheat” that is connected to the node 660 through an intra semantic link 664 “type-of.” The node 662 is associated with a fact instance 668 containing various physical properties of wheat that is connected to the node 662 through an intra semantic link 666 “instance-of.” Specifically, the fact instance 668 contains the USDA food group, scientific name, common name, manufacturers, and percentage of inedible refuse of wheat. In addition to those shown in FIG. 6B, the fact instances for nodes in the food ontology data structure may contain description of the food, factor for converting nitrogen to protein, factor for calculating calories from protein, factor for calculating calories from fat, factor for calculating calories from carbohydrate, taxonomic level such as species or subspecies, taxonomic name, entity part such as plant part of the food.

FIG. 6C illustrates an example plants ontology data structure, according to an embodiment. As shown in FIG. 6C, the plants ontology data structure includes a plurality of hierarchical nodes including a parent node 670 corresponding to “flowers” and a child node 672 corresponding to “tulips” that is connected to the node 670 through an intra semantic link 674 “type-of.” The node 672 is associated with a fact instance 678 containing various physical properties of tulips that is connected to the node 672 through an intra semantic link 676 “instance-of.” Specifically, the fact instance 678 contains the scientific name, the common name, infrakingdom, superdivision, and native region of tulips. In addition to those shown in FIG. 6C, the fact instances for nodes in the plants ontology data structure may contain how long from planting to harvest, typical production yields, USDA growth habit of the plant.

Returning to FIG. 4, the relationships between nodes of different ontology data structures may be represented by inter semantic links. The inter semantic links represent causal, inclusive or other semantic relationships between the nodes. In one instance, an inter semantic link “alleviates” from a source node to a destination node indicates that the source node alleviates a condition specified in the destination node. For example, a node corresponding to carrots in the foods ontology may be connected to carcinoma in the diseases ontology through an inter semantic link “alleviates.” In another instance, an inter semantic link “causes” indicates that the source node causes a phenomenon specified in the destination node. In yet another instance, an inter semantic link “aggravates” indicates that the source node aggravates a condition specified in the destination node. In yet another instance, an inter semantic link “prevents” indicates that the source node prevents a condition or action specified in the destination node. In yet another instance, an inter semantic link “contains” indicates that the source node contains a chemical or ingredient in the destination node. In yet another instance, an inter semantic link “found-in” indicates that the ingredient or chemical in the source node is found in the substance of the destination node. In yet another instance, an inter semantic link “related-to” indicates that the nodes connected by the semantic link are related to each other.

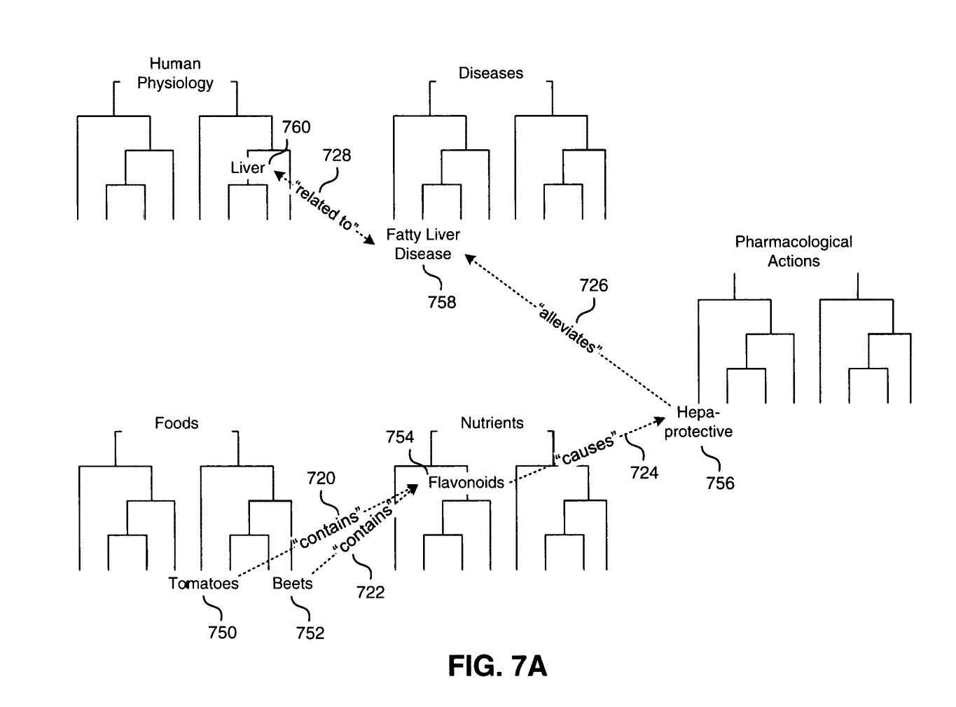

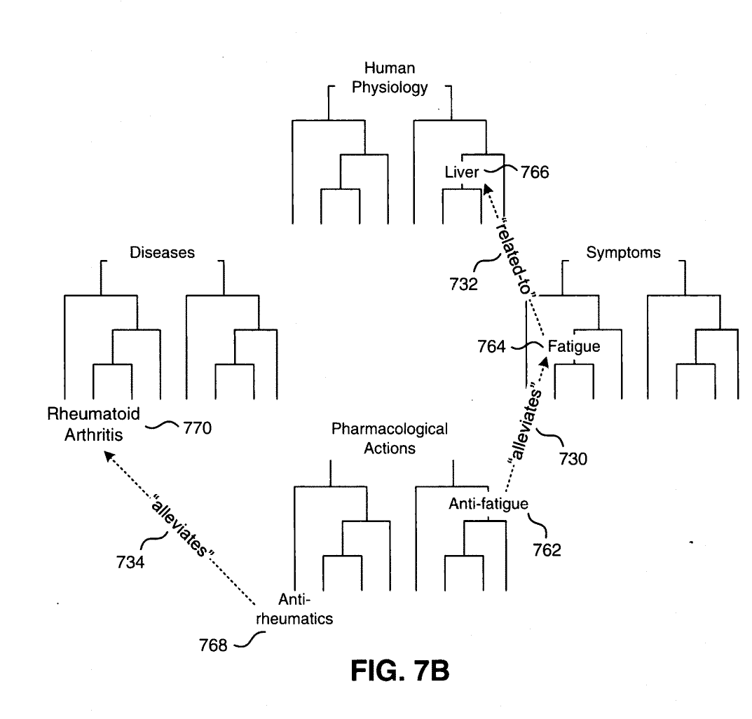

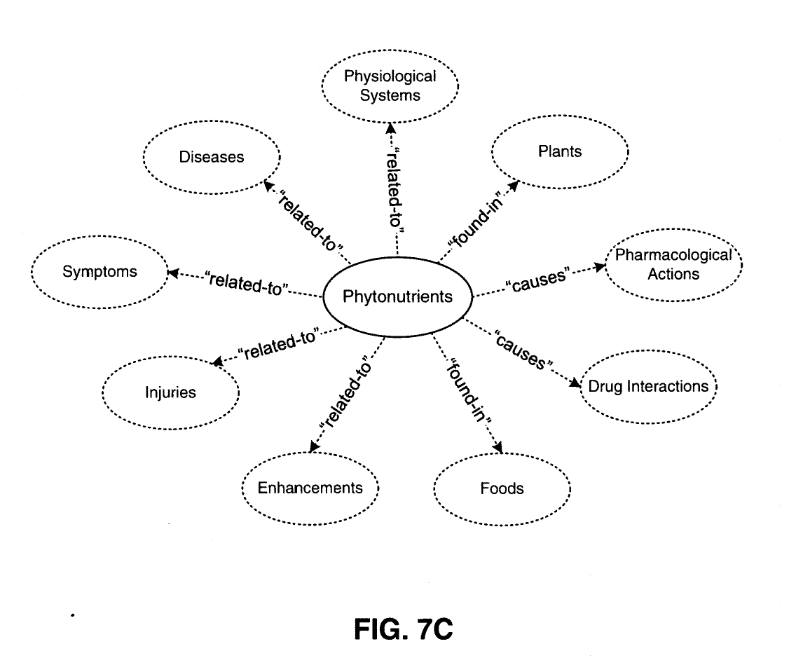

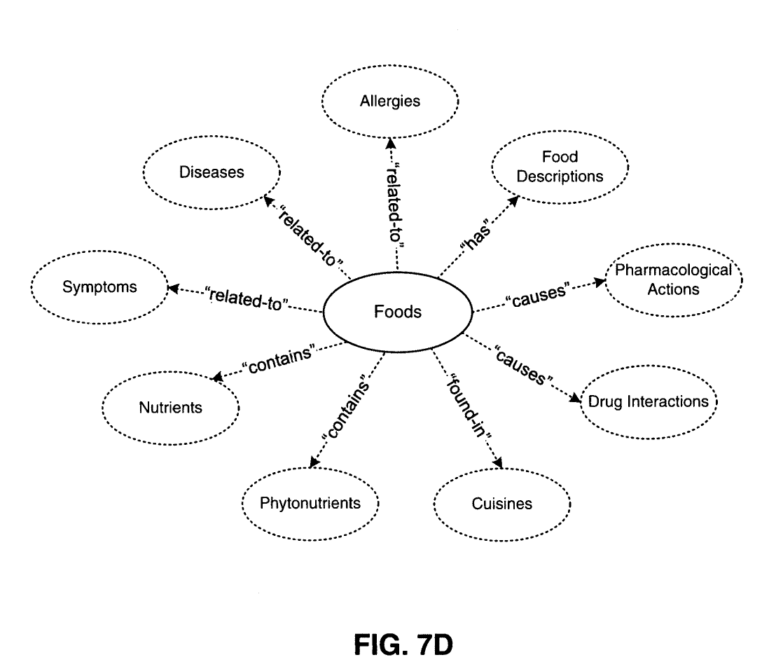

FIG. 7A illustrates a plurality of example inter semantic links between ontology data structures, according to an embodiment. Specifically, FIG. 7A shows a foods ontology, a nutrients ontology, a pharmacological actions ontology, a diseases ontology, and a human physiology ontology of the knowledge database 440. A node 750 corresponding to “tomatoes” and a node 752 corresponding to “beets” in the food ontology are each connected to a node 754 corresponding to “flavonoids” in the nutrients ontology. Each of the semantic links 720, 722 indicates that tomatoes and beets both contain flavonoids. The node 754 corresponding to flavonoids in the nutrients ontology is connected to a node 756 corresponding to “heap-protective” in the pharmacological actions ontology. The semantic link 724 indicates that flavonoids induce heap-protective pharmacological actions. The node 756 corresponding to heap-protective in the pharmacological actions ontology is connected to a node 758 corresponding to “fatty liver disease” in the diseases ontology. The semantic link 726 indicates that heap-protective pharmacological actions alleviate fatty liver disease. The node 758 corresponding to fatty liver disease in the disease ontology is connected to a node 760 corresponding to “liver” in the human physiology ontology. The semantic link 728 indicates that fatty liver disease is related to the organ liver.

FIG. 7B illustrates a plurality of example inter semantic links between ontology data structures, according to another embodiment. Specifically, FIG. 7B shows a pharmacological actions ontology, a symptoms ontology, a human physiology ontology, and a diseases ontology of the knowledge database 440. A node 762 corresponding to “anti-fatigue” in the pharmacological actions ontology is connected to a node 764 corresponding to “fatigue” in the symptoms ontology. The semantic link 730 indicates that anti-fatigue pharmacological actions alleviates fatigue symptoms. The node 764 corresponding to fatigue in the symptoms ontology is connected to a node 766 corresponding to “liver” in the human physiology ontology. The semantic link 732 indicates that fatigue is related to the human organ liver. A node 768 corresponding to “anti-rheumatics” in the pharmacological actions ontology is connected to a node 770 corresponding to “rheumatoid arthritis” in the diseases ontology. The semantic link 734 indicates that anti-rheumatics pharmacological actions alleviate rheumatoid arthritis.

FIG. 7C illustrates a plurality of example inter semantic links for a phytonutrients ontology, according to another embodiment. In general, inter semantic links between nodes may vary depending on the topics of the ontologies associated with the nodes. As shown in FIG. 7C, nodes of a phytonutrients ontology data structure may be connected to nodes of other ontology data structures through different types of inter semantic links. For example, nodes of the phytonutrients ontology can be connected to nodes of the physiological systems ontology, nodes of the diseases ontology, nodes of the symptoms ontology, nodes of the injuries ontology, nodes of the enhancements ontology through semantic links “related-to.” As another example, nodes of the phytonutrients ontology can be connected to nodes of the foods ontology and nodes of the plants ontology through semantic links “found-in.” As yet another′ example, nodes of the phytonutrients ontology can be connected to nodes of the drug interactions ontology and nodes of the pharmacological actions ontology through semantic links “causes.”

FIG. 7D illustrates a plurality of example inter semantic links for a foods ontology, according to another embodiment. As shown in FIG. 7D, nodes of a foods ontology data structure may be connected to nodes of other ontology data structures through different types of inter semantic links. For example, nodes of the foods ontology can be connected to nodes of the allergies ontology, nodes of the diseases ontology, and nodes of the symptoms ontology through semantic links “related-to.” As another example, nodes of the foods ontology can be connected to nodes of the nutrients ontology and nodes of the phytonutrients ontology through semantic links “contains.” As yet another example, nodes of the foods ontology can be connected to nodes of the cuisines ontology through semantic links “found-in.” As yet another example, nodes of the foods ontology can be connected to nodes of the pharmacological actions ontology and the drug interactions ontology through semantic links “causes.” As yet another example, nodes of the foods ontology can be connected to fact instances through semantic links “has.”

By structuring the knowledge database 440 as a plurality of hierarchical data ontologies and a plurality of semantic links, relevant information can be retrieved in a more computationally efficient manner than other existing forms of database structures, especially when the amount of information contained in the database 440 is vastly large. For example, the time required to navigate such an ontology database through semantic links to retrieve nutritional information can be significantly faster than time required to navigate through existing unorganized, separate database structures to retrieve the same type of information that must then be combined and interpreted/understood by the user to be useful. The applications of the nutritional application platform 110 can quickly provide health, nutrition, and wellness related information to consumers in environments where speed is crucial, such as in a hospital setting. It allows for navigation of vast quantities of complex information and relationships in seconds or minutes as opposed to the days or weeks that may be required to get the same result from various disparate collections of information. The database of the nutritional application platform 110 can also be immediately updated in an organized fashion with new nodes and semantic links as new nutritional data or discoveries become available, so that the user always receives the most current information.

Returning to FIG. 4, the knowledge management module 412 may also import ontology data structures from external sources. These may include imported data from hierarchical systems of medical terminology such as ICD-10 and HL-7 that are widely used throughout medical practices and insurance enterprises. Other examples include drugs (NDC), diseases injuries, and symptoms (ICD-10), medical subject headings (MeSH), providers (NUCC/NPPS NPI), toxicity/teratogenicity (CCRIS/GENE-TOX), medications (RxNorm), medical terminologies (HL-7 Code Sets, LOINC, CPT), botany/biology (ITIS), and human physiology (FME). Imported ontologies can provide standard semantics for many different topics, such as diseases, signs, symptoms, injuries, physiological/psychological enhancements, pharmacological actions, toxicity, genetics, drugs, contraindications, side effects, teratogens, active substances, medical specialties, medical procedures, provider types, human physiology, nutrients, and chemicals.

These imported semantics may form a semantic bridge between the nutritional application platform 110 and external enterprise information systems where seamless B2B integration is desired. They can also be used to facilitate a wide range of user interaction through applications developed for the nutritional application platform 110. For example, a consumer planning a recipe to alleviate a specific condition could describe the condition by using the Common Procedural Terminology (CPT) codes for the provider services listed in the Explanation of Benefits (EOB) form that their insurer provides. The knowledge management module 412 can, for example, in many cases associate a specific medical procedure with the underlying condition it is used to treat and from there identify beneficial biochemical nutrients and the foods containing those nutrients. Those foods, in the context of cuisine and relevant culinary practices, provide beneficial options for recipe design that are targeted specifically at a disease, sign, symptom, injury, or physiological/psychological enhancement.

In still other cases external knowledge collections are either too large or change too frequently to allow for economically viable import and maintenance within the context of the knowledge database 440. In these cases, the knowledge management module 412 may use external interfaces to federate with these external repositories to resolve semantic references. In this context, the external repositories are semantically “wrapped” to make it appear as though it were an internal resource. Typical examples of these repositories are chemical reference systems such as anatomical therapeutic chemical (ATC) codes, CAS, ChEBI, ChEMBL, ChemSpider, DrugBank, EINECS, InChl, IUPAC, KEGG, PubChem, SMILES, UNH, and similar systems that are hundreds of gigabytes or more in extent and constantly change as new chemicals are discovered. Many other topics are covered by these repositories including biological, biochemical, botanical, microbial, agricultural, medical, pharmaceutical, commercial foods, genetic, and metabolic pathways.

The knowledge management module 412 may store other types of information other than those stored as ontology data structures. In one instance, the knowledge database 440 stores scaling factors in association with semantic links, such as “contains,” that indicate how much of the substance of the destination node is included in the substance of the source node. Specifically, the scaling factor may be represented as the relative proportion with respect to mass, volume, and/or molar quantities. For example, the knowledge management module 412 may identify a semantic link “contains” from a node corresponding to broccoli in the foods ontology to a node corresponding to threonine in the phytochemicals ontology. In association with the semantic link, the knowledge management module 412 may store a scaling factor of 0.00088 (mass) indicating that threonine makes up 0.088% of phytochemicals in broccoli.

In one instance, the knowledge management module 412 stores geospatial references for ontology data structures that contain food species in the knowledge database 440. Plants, for example, are native to specific regions and invasive in others. Native regions are clues to other similar species that may have evolved under similar conditions and potentially have similar nutrients and pharmacological conditions. Other ontologies can have geospatial relationships as well. Gut microbiota populations will vary by region and have relationships to geospatially situated food resources.

In one instance, the knowledge management module 412 stores various types of information on genetics that can be mapped to corresponding one or more nodes in the plurality of ontology data structures in the knowledge database 440. Genetic information includes plant genetics. Plants have genomes which determine which phytochemicals they contain and hence their pharmacological actions. Collections of related plants can be compared from physical and biochemical perspectives to help identify specific genes responsible for beneficial pharmacological properties. Such analysis can also be used to support selective breeding or genetic modifications to create new plants.

Genetic information can also include nutritional genomics. Nutrigenomics is the science of relationships between the human genome, nutrition and health. For example, given a single-nucleotide polymorphism in a genome that results in the onset of disease, nutrients in foods can be used to bypass the SNP. For example, if a patient has a defect in their MTTR (Methionine Synthase Reductase) gene which regenerates methyl B12 (methylcobalamin) which is needed to detoxify homocysteine and turn it into methionine, the end result is a B-12 deficiency. This can be bypassed by weaving animal foods into the diet such as eggs, dairy, meats, and fish. Databases of nutrigenomics data can be used to supplement nutritional decision support where individual genome data is available in personal profiles.

Genetic information can also include microbiome genetics. Sequencing of a microbe's 16SrRNA gene provides a unique fingerprint for identifying the microbe species, particularly for microbes that cannot be cultured in the lab. This allows for the compilation of databases of microbe species such as the National Center for Biotechnology Information (NCBI) Sequence Read Archive (SRA), the Data Analysis and Coordination Center (DACC) under the Human Microbiome Project (HMP), and the UniProt Metagenomic and Environmental Sequences (UniMES) database that can be accessed by the nutritional application platform 110 and correlated with research reports, peer review papers, diseases, metabolites, signs, symptoms and foods that modulate the populations of specific species. Relevant microbiome species may include, for example, those found in the human gut, skin, or oral cavity, in the soil we use to grow foods, in fermentation processes, and many other environments.

In one instance, the knowledge management module 412 stores information on biochemical pathways in the knowledge database 440. Foods, nutrients, and other components of the ontologies can be mapped to knowledge at the cellular level to pathways that are disease, hormone metabolism, carbohydrate metabolism, lipid metabolism, amino acid metabolism, microbiota metabolism, vitamin metabolism, detoxification, and cellular respiration-specific.

The biochemical pathway information may include biological pathway maps. Biological pathway maps contain knowledge about molecular interaction and reaction networks. Different pathways have causal relationships with foods that are consumed. The biological pathway maps store causal relationships between specific pathways and the nutrients found in foods. The causal relationships can be represented as semantic links between pathway maps, foods, diseases, physiology, research, and other knowledge entities. For example, the Wnt/beta-catenin signaling pathway, and in particular the over-expression of the beta-catenin protein, can be semantically linked in the knowledge database 440 to the occurrence of a number of cancers including colorectal cancer. Certain foods, such as Curcumin, inhibit this pathway and thus, could be useful for cancer prevention or treatment. As another example, in human skin, melanin protects the skin from damage due to ultraviolet (UV) exposure. UV exposure results in aging symptoms and the onset of skin cancer. Once UV damage has occurred due to sunlight exposure, the cellular damage response activation induces melanin production by melanocytes that results in enhanced pigmentation of the skin. This physiologic pathway is a protective response by the skin to prevent further UV damage. The effectiveness of this defensive function is dependent upon the proper functioning of the cutaneous melanocortin 1 receptor (MC1R) signaling pathway. Forskolin, a compound derived diterpenoid extracted from the roots of the Asian Plectranthus barbatus (Coleus forskolii) plant, can be used to protect against UV exposure. Topical application of this skin-permeable compound effectively increases the production of eumelanin, the form of melanin produced by melanocytes that most effectively protects against UV exposure, by upregulating MC1R expression. This information can be used to design new recipes, plan meal schedules, suggest alternatives to expensive pharmaceuticals, suggest changes in growing practices, identify food safety issues, verify research claims, and many other types of services.

The biochemical pathway information may also include carbohydrate metabolism pathways. The carbohydrate metabolism pathways can be used to identify foods that modulate carbohydrate metabolism at the cellular level. Recent research has shown, for example, that bitter phytochemical taste type 2 receptors related to bitter tasting plant phenols, flavonoids, isoflavones, terpenes, and glucosinolates are expressed not just in the oral cavity but throughout the human gut. This research suggests that the human gastrointestinal system recognizes these phytochemicals in foods as signals to regulate glucose metabolism in anticipation of an incoming plant derived carbohydrate load. Such knowledge can be used in the design of new recipes, for example, to compensate for biochemical signals that have been bred out of plants for commercial reasons and thus provide new nutritional treatment alternatives for problematic carbohydrate related diseases such as diabetes.

The biochemical pathway information may also include lipid metabolism maps. The lipid metabolism maps can similarly be used to identify specific biochemical pathways that can be modulated with phytonutrients. Curcumin, the primary polyphenol found in Turmeric, has been shown to modulate lipid and energy metabolism by increasing AMPK (5′ AMP-activates protein kinase) and ACC (acetyl CoA carboxylase) activities by increasing their phosphorylation. This modulation suppresses acetyl CoA conversion to Malonyl CoA, which increases CPT-1 (carnitine palmitoyltransferase-1) expression and thereby increases fatty acid oxidation and subsequent energy release. Thus, there are causal semantic links between Turmeric, its nutrient Curcumin, and an increase in Fatty Acid Oxidation. Such knowledge can be used to support optimization of foods for the treatment of metabolic diseases such as atherosclerosis and familial hypercholesterolemia.

The biochemical pathway information can also include amino acid metabolism pathways. The amino acid metabolism pathways can also be causally linked to nutrient entities in the knowledge database 440. For example, recent in-vivo research studies have indicated that phytochemicals such as phenolic acids (e.g. Chlorogenic acid) found in coffee, apples, pears, tomatoes, and blueberries increase serum levels of amino acids such as glycine. Such causal semantic links support reasoning about the relationships between foods and amino acid levels that can be used to compensate for various amino acid related disorders. Phenylketonuria, for example, is a disorder that occurs in infants that lack the enzyme necessary to convert the amino acid phenylalanine to tyrosine. Phenylalanine, which is toxic to the brain, builds up in the blood causing multiple debilitating symptoms including intellectual disability, seizures, nausea, vomiting, and an eczema-like rash. The therapy for this disorder is a strict phenylalanine-restricted diet allows for normal growth and development. Such information can be used to orchestrate the planning of such diets.

The biochemical pathway information can also include mitochondrial molecular pathways. Many of the biochemical processes involved in cellular respiration occur in mitochondrial molecular pathways that are connected to health, disease, and aging. A wide range of important disorders including dementia, Alzheimer's disease, epilepsy, cancer, Parkinson's disease, ataxia, transient ischemic attack, cardiomyopathy, coronary artery disease, chronic fatigue syndrome, fibromyalgia, diabetes, and primary biliary cirrhosis are related in some way to mitochondrial dysfunction. Phytochemicals found in foods, for example, can modulate the activation of mitochondrial damage/cytochrome c pathways which support the apoptotic process. Almost all cancer cells, for example, are resistant to apoptosis. In some cases this is caused by over-expression of inhibitors of apoptosis proteins such as cytochrome c. The knowledge management module 412 can store semantic links between foods and the phytochemicals they contain to these fundamental mitochondrial pathways. Such information can be used to optimize the impact of foods on cellular respiration and related diseases, signs, and symptoms.

The biochemical pathway information also includes metabolic pathways involved in the body's detoxification process. Food based nutrients have a role in the modulation of metabolic pathways involved in the body's detoxification process. These nutrients specifically impact phase I cytochrome P450 enzymes, phase II conjugation enzymes, Nrf2 signaling, and metallothionein. Nrf2 signaling deficiency has been linked to stress related conditions such as cancer, kidney dysfunction, pulmonary disorders, neurological disease, and cardiovascular disease. For example, The CYP1A family (cytochrome P450, family 1, subfamily A) is involved in metabolizing hormones, procarcinogens, and pharmaceuticals. It is well-known for its role in the carcinogenic bioactivation of polycyclic aromatic hydrocarbons (PAHs), heterocyclic aromatic amines/amides, polychlorinated biphenyls (PCBs), and other environmental toxins. Various foods and phytonutrients alter CYP1 activity. Cruciferous vegetables have been shown, in humans, to act as inducers of CYP1A1 and 1A2, and animal studies also suggest an upregulation of CYP1B1. Clinical studies also indicate that resveratrol and resveratrol-containing foods are CYP1A1 enhancers. Conversely, berries and their constituent polyphenol, ellagic acid, may reduce CYP1A1 overactivity, and apiaceous vegetables and quercetin may attenuate excessive CYP1A2 action. The knowledge management module 412 can store semantic links between these food resources and such detoxification metabolic pathways and the related diseases, signs and symptoms.

In one instance, the knowledge database 440 stores various dietary metrics, such as recommended daily consumption metrics by the USDA. For example, the knowledge database 440 can store metrics on total daily calories, as well as USDA recommended minimum-maximum ranges. As another example, the knowledge database 440 can store metrics on lipids and fats, such as recommended ratios between omega-6 and omega-3, as well as the maximum recommended ratio. As yet another example, the knowledge database 440 can store metrics on lipoic acid (LA) intake, such as recommended intake as a percentage of energy. As yet another example, the knowledge database 440 can store metrics on total fats, such as total recommended calories in fats. As yet another example, the knowledge database 440 can store metrics on saturated fatty acids, such as recommended daily values. As yet another example, the knowledge database 440 can store metrics on cholesterol, such as recommended daily values (e.g., 300 mg/day). As yet another example, the knowledge database 440 can store metrics on soluble and insoluble dietary fiber, such as recommended total fiber and recommended total soluble fiber.

The knowledge management module 412 may add, update, or eliminate existing ontology data structures and their semantic links as new information about the knowledge database 440 becomes available.

The navigation module 416 receives a query and performs inference by navigating through the semantic links of the knowledge database 440 to identify relevant information to the query. Specifically, the navigation module 416 may be associated with one or more applications that provide consumers with relevant nutritional information identified through performing inference on the knowledge database 440. The navigation module 416 may receive the query from an application itself or other modules of the nutritional application platform 110, in which the query contains a request for nutritional information relevant to the subject of the query. The navigation module 416 performs inference by starting from one or more nodes of the knowledge database 440 and navigating through the semantic links of the knowledge database 440 to identify a sub-graph of nodes containing relevant information to the query.

For example, returning to the example semantic links shown in FIG. 7A, the navigation module 416 may receive a query for which foods are beneficial for preventing fatty liver disease. The navigation module 416 may identify a path from the node 758 corresponding to fatty liver disease to the node 756 corresponding to hepa-protective through the semantic link 726 “alleviates.” The navigation module 416 may then identify a path from the node 756 to the node 754 corresponding to flavonoids through the semantic link 724 “causes.” The navigation module 416 may then identify a path from the node 754 to the node 750 corresponding to tomatoes and the node 752 corresponding to beets through the semantic links 720, 722 “contains.” The navigation module 416 may provide tomatoes and beets as the response to the query. The combination of semantic links 720, 722, 724, 726, and 728 constitute a sub-graph that leads to the retrieval of relevant information for the query.

As another example, the navigation module 416 may start with a specific pharmacological action and identify nutrients that are associated with the particular action. The identified nutrients can be traced to plants, animals, fungi, or microbiota where the net effect in the presence of all other nutrients provides a net physiological impact.

As yet another example, the navigation module 416 may start with a specific food and identify diseases, symptoms, signs, injuries, and physiological and psychological enhancements that are connected to the food by the semantic links “alleviates,” “causes,” “aggravates,” or “prevents.”

As yet another example, the navigation module 416 may start with a specific disease such as Inflammatory Bowel Disease (IBD), identify specific microbiota that are known to be associated with active cases of IBD (e.g., Clostridium coccoides, Clostridium leptum, Faecalibacterium prausnitzii), and identify what foods increase or reduce the populations of the undesired microbiota species through semantic links, such that beneficial dietary changes can be identified for a consumer.

As yet another example, a nutrient with a specific pharmacological action can be associated with its corresponding chemical structure. The navigation module 416 may identify similar chemical structures to identify related chemicals that may potentially have similar pharmacological effects as well as other plants that are not known for that physiological impact. Typically, research into plant biochemistry will focus on only one specific pharmacological action. Phytochemicals identified through spectrographic methods may have many other pharmacological actions, in some cases over a hundred, and yet only the narrow pharmacological topic of the research will be identified. The navigation module 416 may identify common chemical structures that can be used to infer unknown actions that could be valuable, for example, in disease prevention or treatment. Such discoveries by the navigation module 416 can be used to lower the cost of conventional medicine by providing low cost nutritional alternatives to high cost pharmaceuticals. Alternatively, such discoveries can lead to the development of new pharmaceuticals, nutraceuticals, or even cosmeceuticals.

As yet another example, the navigation module 416 may start with a specific variety of a vegetable and navigate within the same plant ontology to a more specific species node. From there, the navigation module 416 may access child nodes corresponding to the more specific plant varieties and subspecies. Alternatively, from the species node, the navigation module 416 may navigate to the more general genus node from which all child species are visible.

The knowledge discovery module 420 performs discovery of nutritional information from existing and new sources that can be incorporated into the knowledge database 440. The knowledge discovery module 420 may discover new forms of knowledge from information sources such as the Shallow Web, Deep Web, paywall Internet databases, traditional hardcopies, private databases, and other sources, such as medical research papers, nutritional research papers, biochemical research papers, botanical research papers, ethnobotanical studies, medical references, standard terminologies, recipes, scientific reference works, nutrient data sets, chemical data sets, raw scientific data sets, news articles and releases, and government reports. The Deep Web, in particular, includes data and information objects accessible through the Internet. These are objects, for example, stored in structured, semi-structured, and unstructured data stores that are inaccessible to major search engine indexing agents. They may be in document, media, or data formats that search engine indexing agents do not understand and thus cannot index. Alternatively, they may manifest as objects indexed by search engines that are not accessible through conventional search. Typically, documents that have few or no links to them and no links from them do not achieve a rank sufficient for them to appear in the results list of a search.

In one embodiment, the knowledge discovery module 420 performs automatic classification and categorization of newly ingested data and information. Specifically, manual cataloging can be significantly labor intensive and a limiting factor on the growth of knowledge collections. By automating the classification and categorization process, the knowledge discovery module 420 can drive knowledge base expansion.

In one embodiment, the knowledge discovery module 420 performs graph-based reasoning to infer new patterns and relationships hidden in existing semantic relationships of the knowledge database 440. The knowledge discovery module 420 may infer the new patterns and relationships based on sub-graphs of nodes identified by navigating through the semantic links of the knowledge database 440. For example, the sub-graphs of nodes may be identified by the navigation module 416 while performing inference for relevant information in the knowledge database 440. The knowledge discovery module 420 may provide the identified new relationships to the knowledge management module 412 such that the new information can be incorporated in the knowledge database 440.

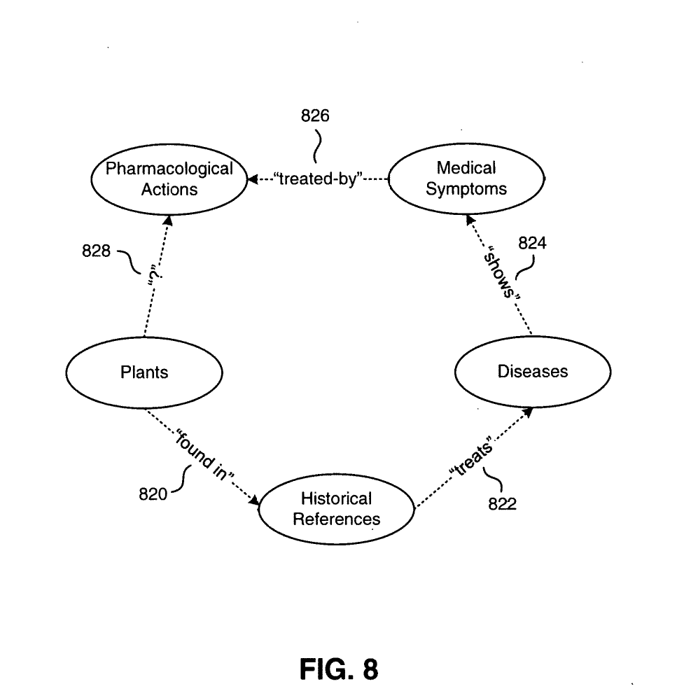

FIG. 8 illustrates an example process for graph-based reasoning based on a sub-graph of nodes identified in the knowledge database 440, according to an embodiment. The example shown in FIG. 8 includes a plants ontology, a historical reference ontology, a diseases ontology, a medical symptoms ontology, and a pharmacological actions ontology. The navigation module 416 identifies a sub-graph of nodes defined by a semantic link 820 “found-in” from a node of the plants ontology to a node of the historical references ontology, a semantic link 822 “treats” from the node of the historical references ontology to a node of the diseases ontology, a semantic link 824 “shows” from the node of the diseases ontology to a node of the medical symptoms ontology, and a semantic link 826 “treated-by” from the node of the medical symptoms ontology to a node of the pharmacological actions ontology. Based on the identified sub-graph, the knowledge discovery module 420 may identify a possible semantic link 828 between the node of the pharmacological actions ontology and the node of the plants ontology. The knowledge discovery module 420 may provide the semantic link 828 to the knowledge management module 412 for incorporation into the knowledge database 440.

Returning to FIG. 4, in one embodiment, the knowledge discovery module 420 performs geospatial reasoning to identify possible geospatial associations that can be inferred from the knowledge database 440. For example, if a plant species found in a particular geospatial region has a known pharmacological action, the knowledge discovery module 420 can use geospatial data to identify other regions around the world with similar topography, soil conditions, weather patterns, watersheds, drainage basins, surface water configurations, as well as other geospatial features that could indicate other areas where the plant species can be found, areas where similar plant species can be found, and areas suitable for cultivation and production of the plant species.

In one embodiment, the knowledge discovery module 420 performs temporal reasoning to understand relationships between knowledge entities. For example, the recommended dosage for a drug can be interpreted as a consensus built up over time when assessing patterns of in vitro and in vivo research studies in large scale human clinical trials. Temporal relationships indicate the sparseness or abundance of research studies over time. For example, a small number of in vitro studies with one subsequent in vitro rat study in the distant past can carry less weight than a long consistent pattern of related studies over the years leading to a recent large scale human clinical trial. The temporal relationships connecting such research and clinical evidence can be used, with other factors, in the compilation of a confidence value for dosage based on research provenance that can be useful for quantitative recommendations.

In one embodiment, the knowledge discovery module 420 uses vector space approaches to retrieve information on the conceptual closeness of entities ranging from highly unstructured textual documents to highly structured data objects. In the case of unstructured documents such as research papers, terms and phrases can be used to identify underlying key concepts and weighted based on inverse frequency and structural keys. Each term or phrase can be represented as a dimension in an N-dimensional document space. Within such a space a document can be represented by an N-dimensional vector. The angle between such vectors can be sued as a measure to reason about conceptual similarity between documents. This may be useful, for example, in assembling and evaluating provenance for estimates for nutrient dosage.

In one embodiment, the knowledge discovery module 420 can use supervised and unsupervised learning techniques such as statistical pattern recognition, text mining, deep reinforcement learning to discover knowledge and semantic relationships from newly ingested data and information and external enterprise data stores. For example, the knowledge discovery module 420 may learn new semantics for known ontology topics, such as new plant varieties or new forms of biochemical nutrients. As another example, the knowledge discovery module 420 may learn new information for fact instances in the knowledge database 440, such as a new brand of an ingredient, a new recipe, or a new treatment protocol. As yet another example, the knowledge discovery module 420 may learn new semantic connections within or between ontology data structures, such as a new type of causation between a food and a disease, a plant and a pharmacological action, or a nutrient and a cellular pathway. As yet another example, the knowledge discovery module 420 may learn emergent trends in areas such as food consumption or disease etiology. As yet another example, the knowledge discovery module 420 may learn new ontology topics that have emerged in the literature, such as metabolomics. As yet another example, the knowledge discovery module 420 may learn new patterns of disease etiology and epidemiology.

In one embodiment, the knowledge discovery module 420 aids in the discovery of causal relationships between specific pathways and the nutrients found in foods. The causal relationships can be provided to the knowledge management module 412 for storage in the knowledge database 440.

Specifically, the knowledge discovery module 420 maintains external interfaces to large, dynamic collections of such maps (e.g. KEGG, Reactome, BioCyc) and data mines the map annotations and structures to discover causal relationships between specific pathways and the nutrients found in foods. Many biological pathway maps are found in graphical image formats, included in peer review articles, books, reports, or published on Internet Web sites. Mining of such diagram formats requires a multi-phased, combined top-down (from the image) and bottom-up (from the language) approach. Initially, the knowledge discovery module 420 can analyze the diagram with Optical Character Recognition (OCR) tools to extract diagram annotations and terminology (i.e. semantics) and their graphical coordinates and spatial extents, thereby separating them from the graphics. The knowledge discovery module 420 can use the extracted terms to search for initial candidate semantic links into the existing ontology data structures. Knowledge extracted from such discovered relationships can be used to assist in the recognition of objects in the diagrams forming constraints that propagate through the diagram parsing and recognition process. Knowledge of biochemical diagramming formalisms is also used by the diagram parser in the process of recognizing diagrammatic features. At a deeper level, the next phase involves diagram structure recognition where shapes and links are recognized and correlated with the extracted annotations and terminology. The extracted structure provides candidate linkage between annotations and terminologies extracted in the first pass. In some cases, extracted terminology will be enclosed within shapes and hence represent candidate knowledge entities. In other cases, adjacency between annotation terms and lines (i.e. links between entities) may indicate a “typing” of semantic links. In cases where there are large numbers of highly similar diagrams the extraction process can be automated subject to quality control constraints. In other cases, diagrams containing new and unknown structural features will require subsequent review by human subject matter experts following the extraction process which in some cases may become interactive and iterative.

The knowledge discovery module 420 supports various types of reasoning services, in addition to those discussed above, to determine casual relationships between foods to signs, symptoms, disease, injuries, and physical/cognitive performance enhancements, and cellular-level human biological pathways.

In one instance, the knowledge discovery module 420 supports reasoning services to link foods to signs, symptoms, disorders, injuries or potential physical or cognitive enhancements through the actions of their cofactors and coenzyme constituents on metabolic pathways. Specifically, metabolic pathways and the enzymes that convert metabolites and intermediates within them, require non-protein helpers such as cofactors or coenzymes (organic cofactors) for normal catalytic activity to take place that drives cellular chemical reactions. Dietary vitamins, for example, can be organic coenzymes for metabolic pathways or form the raw materials from which such coenzymes are synthesized. Minerals found in foods such as zinc, iron and copper in ionic form function as inorganic cofactors. The knowledge discovery module 420 can identify links between foods and such metabolic pathways.

In one instance, the knowledge discovery module 420 supports reasoning services to link foods to pharmacological effects by associating their constituent nutrients to the modulation of signaling pathways. Specifically, signaling pathways are part of the communications process that governs and coordinates cellular activities. These pathways have been linked to disease onset and progression. Aberrant functioning of the Wnt/β-catenin signaling pathway, for example, has been observed in a variety of human cancers including colorectal, prostate and melanomas. Dietary agents that are antagonists of the Wnt/β-catenin signaling pathway have been shown to have cancer chemo preventive effects. The knowledge discovery module 420 can identify links between the foods and these signaling pathways, as well as their associated pharmacological effects.

In one instance, the knowledge discovery module 420 supports reasoning services to link foods to signs, symptoms, disorders, injuries, or potential physical or cognitive enhancements through the actions of competitive inhibitors on biochemical pathways. Specifically, competitive inhibitors are molecules similar to the metabolite or intermediate substrate but unable to be acted on by the enzyme and thereby compete with the substrate for the enzyme active site. Foods contain biochemicals, for example, that are competitive inhibitors of proteases that break down proteins into smaller polypeptides or amino acids. Proteases such as pepsin, trypsin, and chymotrypsin, for example, are produced by the digestive tract for breaking down proteins. Instances of food based competitive inhibitors are flavonoids, phytochemicals found commonly in foods such yellow onion, kale, leek, parsley, soy, tea, and blueberry. Flavonoids inhibit the NF-κB signaling pathway that is believed to suppress cell apoptosis and promote cancer cell growth. Similarly, flavonoids have been shown to inhibit pathways linked to the occurrence of inflammation. The knowledge discovery module 420 can link these foods and nutrients to actions of competitor inhibitors on biochemical pathways.

In one instance, the knowledge discovery module 420 supports reasoning services to link foods to gene expression. Specifically, dietary patterns and their constituent foods regulate pathway gene expression signatures and profiles. Such profiles are associated with the functioning of physiological systems such as the immune system and disorders such as inflammation, cancer, or cardiovascular disease. The HLA-B27 gene, for example, is associated with the onset of autoimmune disease and has been shown to have environmental triggers. One of these triggers is now believed to be the presence of starchy foods in the diet. Similarly meat-related foods in the diet have been associated with dysregulated genes that are causally related to cancer and tumor morphology in the human colon. The knowledge discovery module 420 can link foods to gene expression such that the identified links can be used to help prevent signs, symptoms, disease, and promote the overall health of physiological systems.

In one instance, the knowledge discovery module 420 supports reasoning services to link foods to alternative biological pathways that provide similar effects to pathways that have been compromised. Specifically, the normal functioning of biological pathways can be disrupted by disease or gene mutations. The knowledge discovery module 420 can identify foods that leverage alternative biological pathways that provide similar effects, such that these types of foods can be recommended to, for example, a patient. For example, given a single-nucleotide polymorphism (SNP) in a genome that results in the onset of disease, nutrients in foods can be used to bypass the SNP. For example, if a patient has a defect in their MTTR (Methionine Synthase Reductase) gene which regenerates methyl B12 (methylcobalamin) for detoxifying homocysteine and turning it into methionine, the end result is a B-12 deficiency. This can be bypassed by adding methylcobalamin rich animal foods into the diet such as eggs, dairy, meats, and fish.

The food analysis module 422 analyzes recipes of food with respect to their ingredients, and provides information on the wellness of the recipes. Specifically, the food analysis module 422 may be associated with an application that provides design of foods based on wellness objectives of consumers. The recipe may represent a set of ingredients, and may include a set of ingredients for a single dish, or may alternatively include a set of ingredients that a consumer has consumed over a daily, weekly, monthly period, and the like.

The food analysis module 422 receives information on a recipe including a set of ingredients, and analyzes various metrics that indicate the wellness of the recipe. For example, the food analysis module 422 may analyze the total caloric intake of a recipe in terms of fats, carbohydrates, and protein. As another example, the food analysis module 422 may evaluate the aggregate effectiveness of the recipe in terms of particular physiological enhancements and the like. Specifically, the food analysis module 422 can obtain the breakdown of nutrients for each ingredient, as well as the aggregate breakdown for the recipe itself through information contained in the knowledge database 440 responsive to receiving a recipe. The food analysis module 422 can determine various effectiveness metrics of the recipe through this breakdown. In one embodiment, the food analysis module 422 additionally receives constraints associated with the recipes, and may evaluate the effectiveness of the recipes with respect to those constraints. For example, the food analysis module 422 may receive a recipe and a constraint “prevention of hypertension,” and evaluate the effectiveness of the recipe in terms of preventing hypertension.

The behavioral planning module 424 provides planning services to generate and update temporal wellness plans, such as dietary meal plans, nutritional treatment regimens, and other wellness functions that occur over time. Specifically, the behavioral planning module 424 may be associated with an application that provides a nutritional consumption plan based on wellness objectives of consumers. The behavioral planning module 424 receives information on a consumer of the application and generates, as well as updates, a wellness plan for the consumer based on information contained in the knowledge database 440, and among others, the reasoning and decision support services provided by other modules of the application platform 110. For example, the consumer information may include a consumers' height, weight, body fat percentage, and a dietary objective to enhance metabolism rate. Based on the consumer information, the behavioral planning module 424 can generate a dietary plan over a subsequent number of weeks that will help the consumer gain a higher metabolism rate.

In one embodiment, the behavioral planning module 424 also detects deviations from wellness plans, and dynamically updates wellness plans responsive to detecting the deviations. For example, in the case of meal plans, consumers might often deviate from the meal plan at one point. The deviations may occur, for example, at well-defined events such as birthday celebrations, office parties, customer meetings over lunch or dinner, unpleasant or traumatic personal experiences. The deviations may also occur at less well-defined events such as a bad day at the office. In such an embodiment, the behavioral planning module 424 receives consumer information including what users have consumed, and detects deviations from the original wellness plan by comparing consumed items with those planned. The behavioral planning module 424 can re-plan future meals to compensate for the deviation. For example, the behavioral planning module 424 may re-plan by boosting nutrient values, lowering saturated fats, reducing caloric intake, increasing omega-3 fatty acids, and the like. Alternatively, the behavioral planning module 424 receives consumer information including deviations from a wellness plan that is, for example, manually entered into the application by a consumer him/herself.

In one embodiment, the behavioral planning module 424 may use machine-learning techniques to learn consumer behavior. Consumer behavior represents a challenging topic for behavior modeling and prediction given the variability in behavior associated with age, income, culture, education, stress, physical state, external events, gender, weight, ethnicity, personal genome, income level, education level, profession, diseases, signs, symptoms, injuries, medical treatments, group influences, social context, cultural factors, economic factors, psychological factors, nutrition and disease etiology, and other variables specific to an individual. The behavioral planning module 424 receives consumer information including the various types of variables of a consumer, and uses statistical learning methods, such as Bayesian multi-variate regression, to construct probabilistic models of consumer behavior or emotional state. In one instance, the consumer information may also indicate a situated event of a consumer under a wellness plan, and the behavioral planning module 424 may suggest foods that may minimize the deviation from the dietary plan using the machine-learned models. In another instance, the behavioral planning module 424 can re-plan a dietary plan using the machine-learned models subsequent a plan deviation resulting from an event. Ultimately, the behavioral planning module 424 may receive dietary choices made under event-driven conditions from multiple consumers of the application that can be stored in a data store. The behavioral planning module 424 can use the stored data to train the machine-learned models used to predict consumers' behavior that will become increasingly more accurate over time.

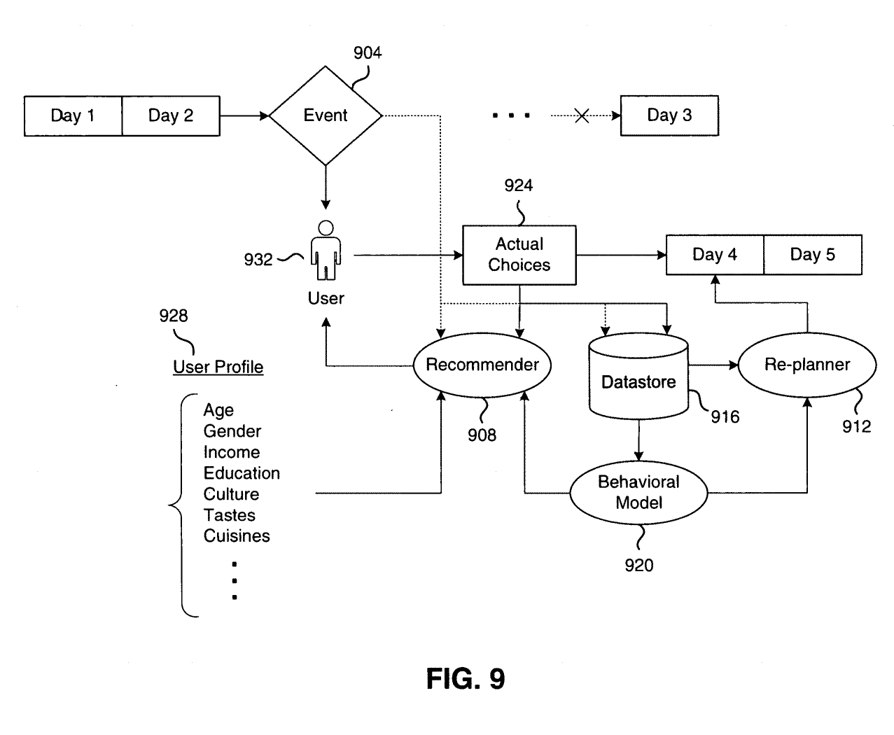

FIG. 9 illustrates an example process of recommending and re-planning a wellness plan for a consumer based on a machine-learned behavioral model, according to an embodiment. In one embodiment, the functions and processes shown in FIG. 9 are performed by the behavioral planning module 424.

Specifically, a user 932 of a meal planning application supported by the application platform 110 may be associated with a meal plan generated by the behavioral planning module 424. On day 2 from the start of the meal plan, the user 932 experiences a deviation in the meal plan due to an event 904 such as a birthday party. The behavioral planning module 424 includes a recommender 908 that identifies healthier alternatives that fit the environment of the event 904. The recommender 908 receives a set of user profiles 928 describing the user of the application, description of the event, and the actual choices 924 made by the user 932 from the application. The recommender 908 also receives access to a behavioral model 920 that generates predictions of user behavior. The behavioral model 920 may be a machine-learned model. Based on the behavioral model 920 and the received information about the user 932, the recommender 908 can identify alternative options that fit the event 904, and provide these options to the application. The behavioral planning module 424 also includes a re-planner 912 that updates the meal plan for the user 932 to compensate for the deviation caused by the event 904. The re-planner 912 also receives the actual choices 924 made by the user 932 and access to the behavioral model 920. The re-planner 912 can identify re-planning options for subsequent days, for example, day 4 and day 5, that will help the user 932 back on track on his/her meal plan.

Additionally, the actual choices 924 of the user 932, as well as the set of user profiles 928 of the user 932 can be stored in a data store 916 in addition to stored information on other users of the application. The behavioral planning module 424 can use the data in the data store 916 to train the behavioral model 920 and improve accuracy of the behavioral model 920.

Returning to FIG. 4, the semantic middleware 928 provides a gateway to a variety of services offered by the nutritional application platform 110, including those offered by the navigation module 416, the knowledge discovery module 420, and the behavioral planning module 424. The semantic middleware 928 receives requests from applications or external interfaces supported by the nutritional application platform 110, and coordinates which services will respond to the requests. The semantic middleware 482 provides the responses to the requester.

In one embodiment, the semantic middleware 928 also provides a query interface and grammar processing services that allow applications or external interfaces to search through the knowledge database 440 or other stored knowledge databases of the nutritional application platform 110, such as structured or unstructured data stores. The semantic middleware 928 supports knowledge query grammar that expresses syntactic, semantic, and structural references to stored knowledge. The semantic middleware 928 may also support filtering by geospatial region and temporal period.

The semantic middleware 928 implements a variety of query grammars. For example, the semantic middleware 928 may support Boolean search grammar, such as “plant AND instance AND genus=Solanum.” As another example, the semantic middleware 928 may support physical similarity search that includes plants with similar phytotomy, plants with similar morphology, and diseases with similar signs or symptoms. As yet another example, the semantic middleware 928 may support structural similarity search that includes nutrients with similar molecular structure and molecular pathways with similar structure. As yet another example, the semantic middleware 928 may support textual similarity or vector space search that includes research papers with similar topics, recipes with similar ingredients, and diseases with similar symptoms. As yet another example, the semantic middleware 928 may support taxonomic similarity search that includes plant species in the same genus. As yet another example, the semantic middleware 928 may support process similarity search that includes ingredients with similar culinary uses, foods with similar preparation processes, and medical treatments with similar medical therapies. As yet another example, the semantic middleware 928 may support geospatial search that includes plants found in a common region, plants with similar growing conditions, and foods common to a specific region. As yet another example, the semantic middleware 928 may support ethnobotanical search that includes historical cures with a specific pharmacological action. As yet another example, the semantic middleware 928 may support term and/or phrase synonymy that includes chemicals, drugs, plants, foods, medical procedures, medical specialties, diseases, signs, symptoms, injuries, and deceptive or misleading food labeling. For similarity search queries, the semantic middleware 928 may receive a query, identify elements of the knowledge database 440 that have a degree of similarity with the query, and return elements associated with a degree of similarity above a predetermined threshold to the requester. The degree of similarity can be represented, for example, as a cosine of an angle between two vectors when the elements are represented as vectors in an n-dimensional space, a degree of similarity in chemical structure, and the like.

The applications services module 432 builds and deploys one or more applications 444 supported by the nutritional application platform 110 to client devices 116. The application services module 432 can design a wide variety of applications 444 around the knowledge database and internal services of the nutritional application platform 110. The applications 444 include the necessary components needed to deploy mobile applications, web applications, B2B applications, and the like. The components may also include those that generate graphical user interfaces (GUI) at the client devices 116 that users can use to interact with the application platform 110 or view data obtained from the application platform 110 among other things. In one embodiment, the applications 444 are configured to communicate with various components of the nutritional application platform 110 to respond to a query or request received from one or more users. In another embodiment, the databases and reasoning and decision support services of the nutritional application platform 110 may be built-in the applications 444, and the applications 444 may service users without the need to communicate with components of the nutritional application platform 110.

The applications services module 432 also manages a user information data store 448 that stores information about users of the application platform 110. These may include individual or organizational consumers that are users of applications 444 of the platform, or users that access resources of the application platform 110 through another means such as an interface to the application platform 110. In one instance, the user information 448 includes physical characteristics of the users, such as weight and height of a user. In another instance, the user information 448 includes health-related information of the user, such as information from diagnostic laboratory tests, general wellness tests, and the like. Additionally, the user information 448 includes historical information of the user, such as genetic history, disease history, and the like. Additionally, the user information 448 includes dietary preferences of the user that indicate, for example, particular diets that a user is pursuing, or the user's palette preferences for food. Internal services of the nutritional application platform 110 can use the user information 448 in conjunction with the applications 444 to provide nutritional guidance that is tailored to the user.

In one instance, the applications 444 include food design applications that leverage semantic links between foods and nutrients, pharmacological actions, diseases, signs, symptoms, physiological and/or psychological enhancements, and other entities in the knowledge database 440. The application services module 432 can design such applications from multiple perspectives. For example, the application services module 432 can consider perspectives from individual consumer use, institutional food services, processed food manufacturers, school food planning, government nutritional standards, restaurant menu design, and military food engineering. For each perspective, food design applications design foods from a set of ingredients, additives, and colors to comply with a set of constraints provided to the applications.

In one instance, a food design application allows users to submit search queries in either a Boolean structured or an unstructured full text search. For example, the application can allow users to locate a specific ingredient for a recipe. As another example, starting with a food group category, the application can allow users to browse through food ingredients within that category. The food design application can provide the query submission to, for example, the semantic middleware 428 of the application platform 110 to retrieve the response for these queries.

The food design application allows users to add ingredients for food design through, for example, a GUI component. In one instance, the food design application allows a user to select an ingredient and specify a unit measure (e.g., tsp, tbsp., cup, pint) and a scaling factor associated with the ingredient. For example, a user may enter “½ cup raw broccoli,” in which the ingredient is raw broccoli, the unit measure is cup, and the scaling factor is ½. The food design application may convert the unit measures into their equivalent weights (e.g., grams) based on the density of each ingredient. In conjunction with the food analysis module 422, for example, the food design application can obtain the amount of nutrients contained in each ingredient. For example, the ingredient “½ cup raw broccoli” can be converted to a gram equivalent weight. The food design application can then obtain the breakdown of phytonutrients in broccoli based on the scaling factors for phytonutrients to determine the gram equivalent weight of phytonutrients included in broccoli. Additionally, the application may allow the user to select from libraries of culinary descriptors (e.g., organic, fresh, raw) and preparatory descriptors (e.g., chopped, sliced, braised) as well.

In one instance, as each ingredient is added to a recipe, the food design application provides re-analysis on the updated recipe. For example, the food design application may obtain re-analysis for the recipe for co-factors necessary for proper nutrient metabolism. A built-in recommender in the food design application or a recommender in conjunction with the food analysis module 422 may suggest ways to re-balance cofactors by adjusting ingredient quantities or adding additional ingredients suitable for the culinary context. For example, the piperine alkaloid in black pepper has been shown in research studies to improve the bioavailability of curcumin in Turmeric by as much as 150%. The recommender may suggest the addition of black pepper in a recipe including Turmeric to increase the bioavailability of curcumin.

In one instance, the food design application can present nutrients according to their quantity in one or more ingredients. For example, the food design application can present nutrients contained in a selected set of ingredients according to their quantity in the ingredients. Since there can be a large number of nutrients, the food design application can allow the user to choose the top N nutrients for display. The food design application can also present nutrients that are filtered based on associated pharmacological actions or other conditions for display. For example, the food design application can filter the nutrients based on the pharmacological actions obtained from the knowledge database 440.

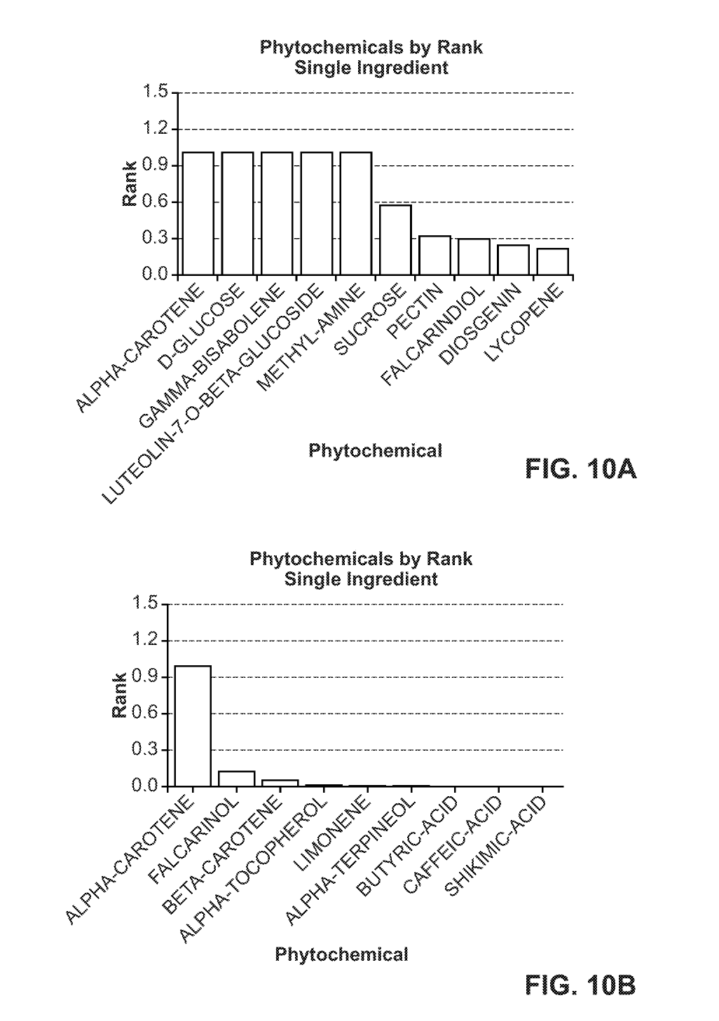

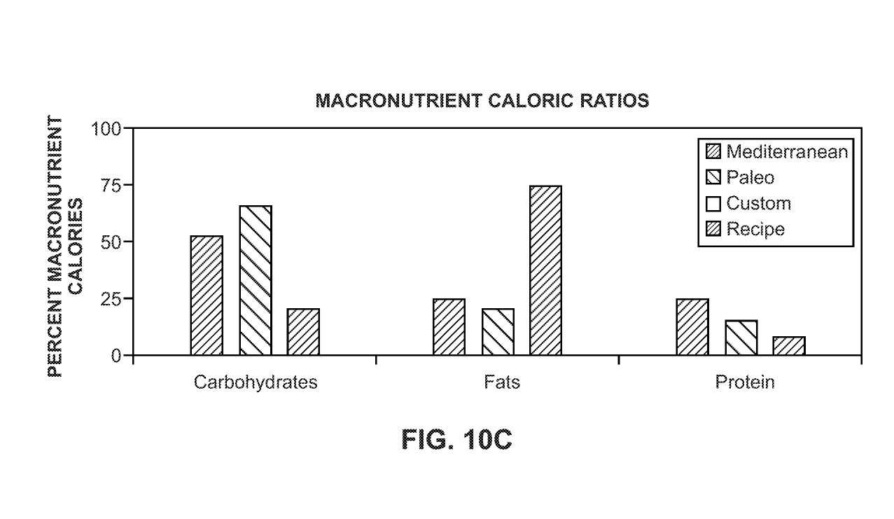

FIG. 10A is an example graphical user interface for presenting phytochemicals contained in carrots, according to an embodiment. FIG. 10B is an example graphical user interface for presenting a filtered set of phytochemicals contained in carrots, according to an embodiment. As shown in FIG. 10A, an example food design application displays a ranked list of the top ten phytonutrients contained in carrots based on a normalized quantity. Specifically, alpha-carotene has the highest relative proportion among phytonutrients included in carrots, followed by d-glucose, gamma-bisabolene, luteolin-7-beta-glucoside, methyl-amine, sucrose, pectin, falcarindiol, diosgenin, and lycopene. As shown in FIG. 10B, the food design application may present a filtered subset of phytonutrients that are specifically associated with anti-cancer pharmacological actions. Specifically, alpha-carotene has the highest proportion among phytonutrients with anti-cancer pharmacological actions, followed by falcarinol, beta-carotene, alpha-tocopherol, limonene, alpha-terpineol, butyric-acid, caffeic-acid, and shikmic-acid. In addition, the food design application may allow the user to select any one of the phytonutrients to obtain deeper knowledge about the phytonutrient, such as toxicity, teratogenic effects, side effects, drug interactions, pharmacological actions, botanical science, ethnobotanical data, and organic chemistry.

In one instance, the food design application supports tracking of aggregate caloric ratios as a recipe is built up. The food design application can allow users to select one or more reference diets for display as well as enter a custom ratio, which can be displayed with a current recipe ratio. The food design application may also provide dietary metrics such as daily calories, metrics for lipid and fats, lipoic acid, total fats, saturated fatty acids, cholesterol, and the like for the recipe in conjunction with the recommended dietary metrics. For example, the food design application can display dietary metrics of the recipe and the recommended dietary metrics in a side-by-side manner.

FIG. 10C is an example graphical user interface for presenting aggregate caloric ratios between carbohydrates, fats, and protein for multiple diets, according to an embodiment. As shown in FIG. 10C, the graphics display caloric ratios between carbohydrates, fats, and protein for a Mediterranean diet, a paleo-diet, a custom diet, and the current recipe being analyzed. Similarly to the examples shown in FIGS. 10A and 10B, the food design application can take into account constraints for specific pharmacological actions (e.g., anti-cancer, anti-inflammatory), diseases, signs, symptoms, or desired physiological and/or psychological enhancements.

In one instance, the recommender included in the food design application can provide alternative strategies when certain metrics exceed or fall below recommended values. For example, given information that a user consumes 2,000 calories per day and exceeds the recommended 2.3:1 n-6/n-3 ratio, the recommender can provide a first alternative strategy of making no changes to n-6 intake and increasing intake of EPA & DHA to 3.67 g/day, which can be achieved by 11-oz. of oily fish every day. The recommender can provide a second alternative strategy of reducing n-6 intake to approximately 3% of calories, and consume 0.65 g/day (three 4-oz. portions of oily fish per week) of EPA & DHA. The recommender can provide a third alternative strategy of limiting n-6 intake to less than 2% of calories, and consume approximately 0.35 g/day of EPA & DHA (two 4-oz. portions of oily fish per week). The recommender can also provide a strategy of recommending supplements when dietary intake remains below optimal levels.

In one instance, the food design application can obtain various metrics indicating the wellness of the recipe and the effectiveness of the recipe with respect to one or more wellness goals. The food design application can present the obtained metrics to the consumer, such that the consumer can track the progress of an associated wellness goal. The food design application can also receive a constraint such as “prevention of hypertension,” and obtain the effectiveness of the recipe with respect to the constraint, and suggest alternative ingredient choices that are beneficial for the constraint.

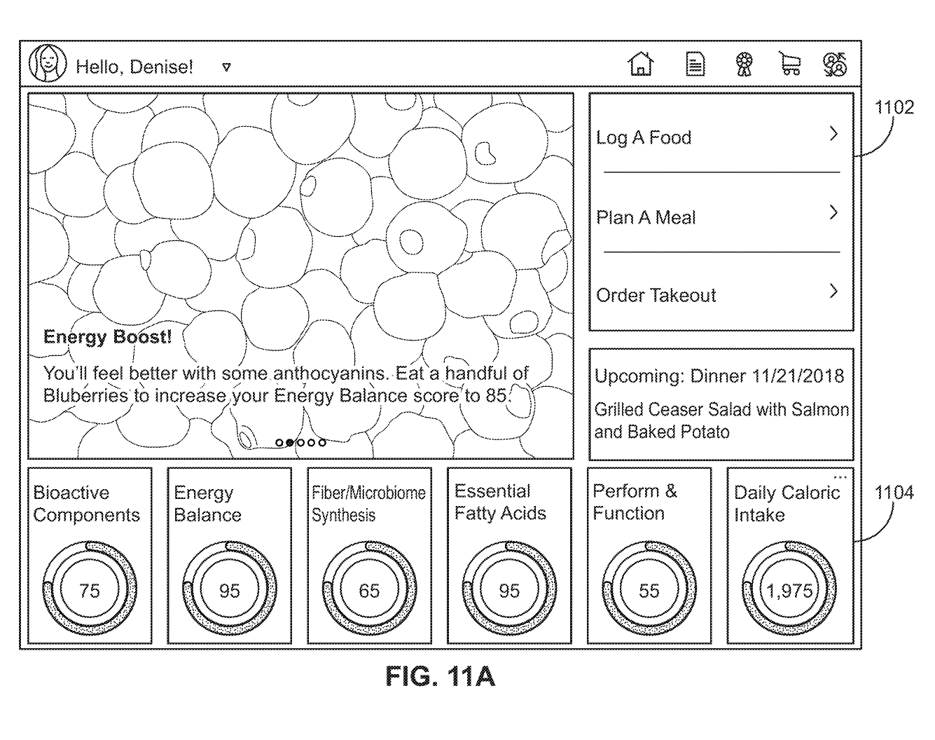

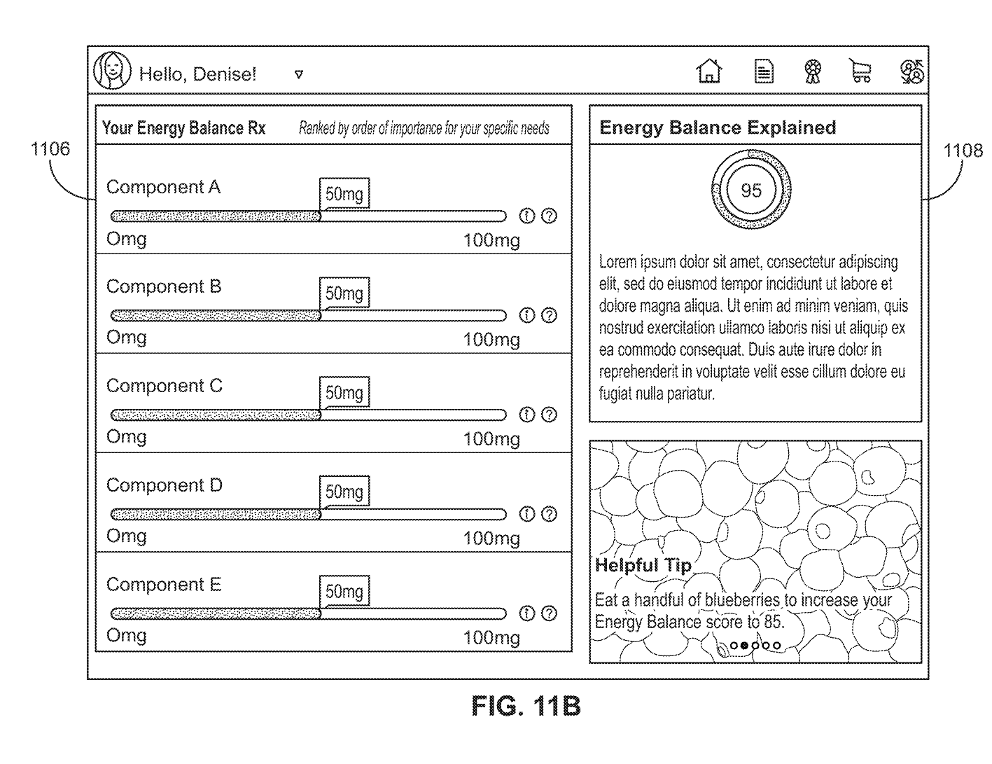

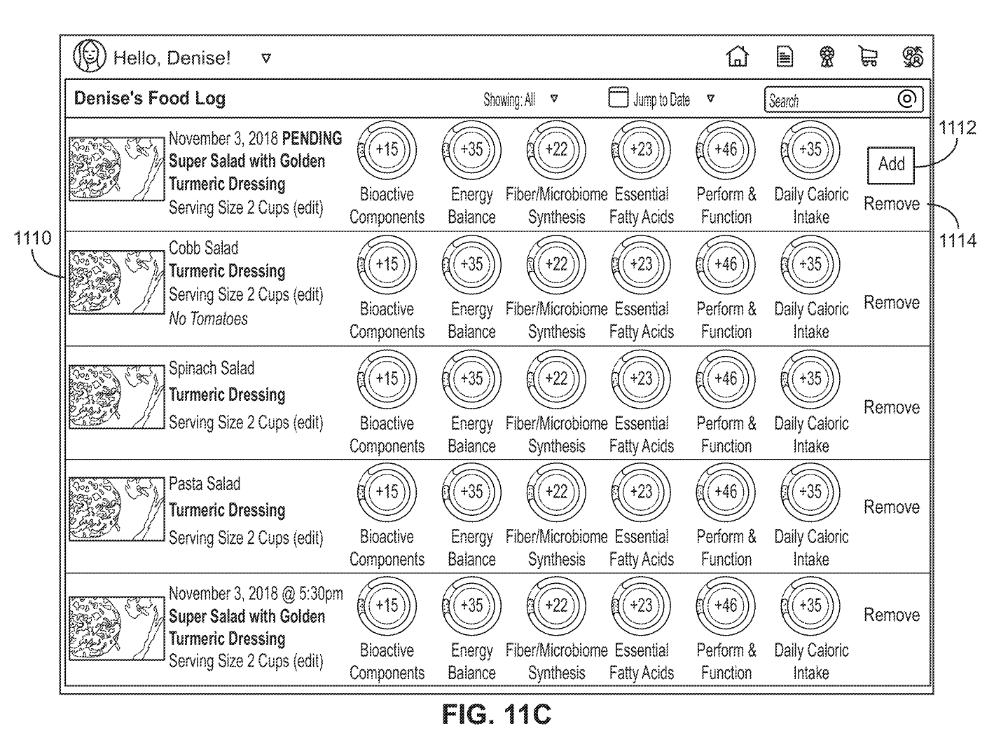

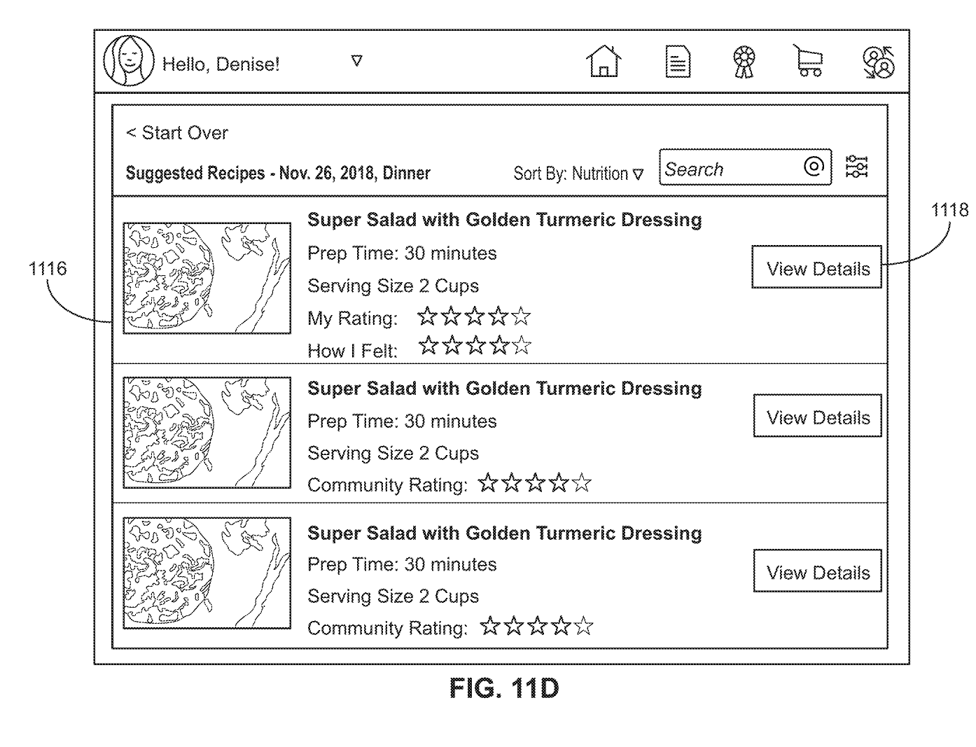

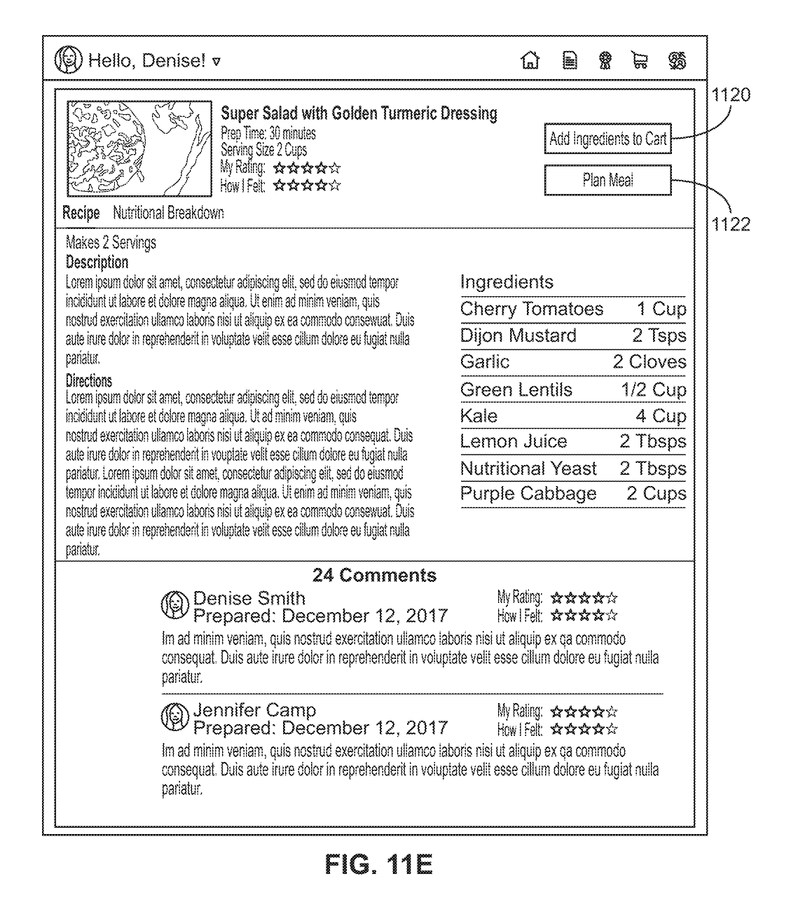

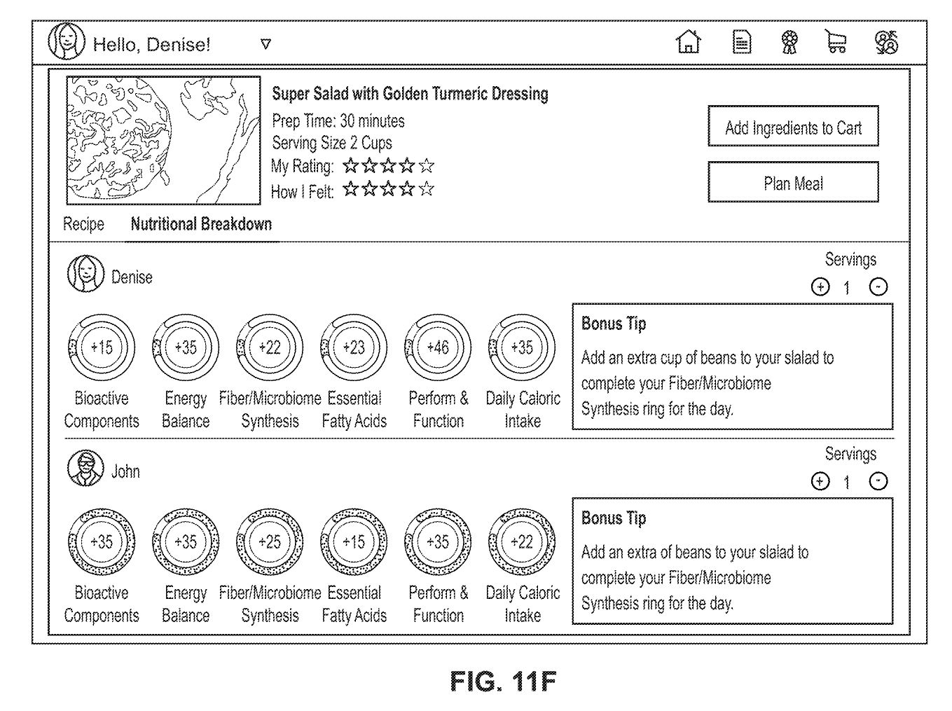

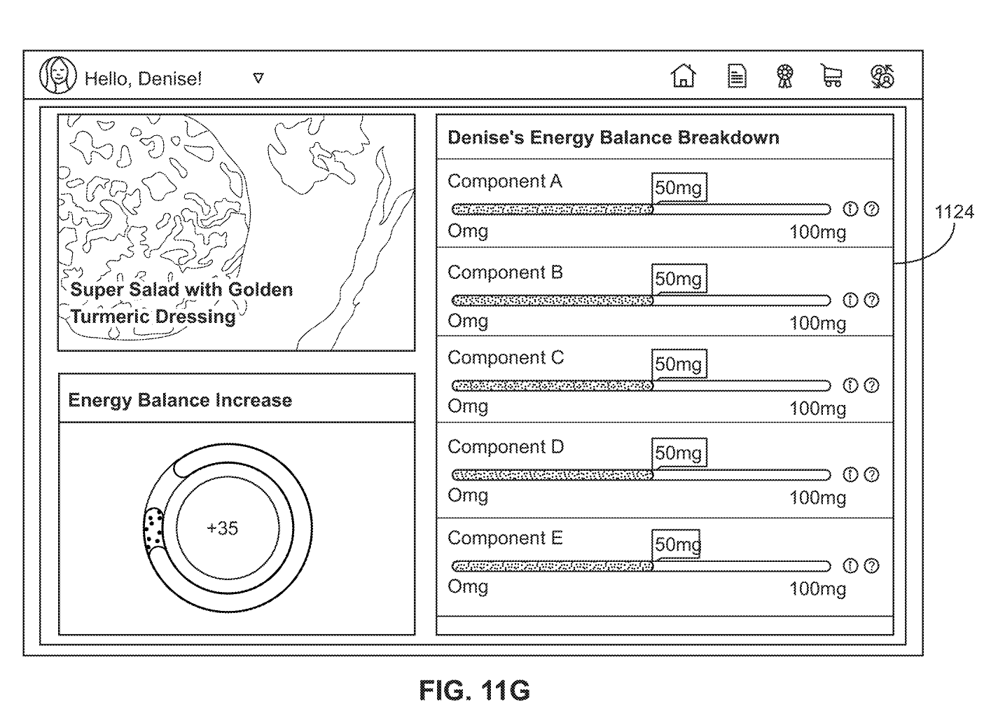

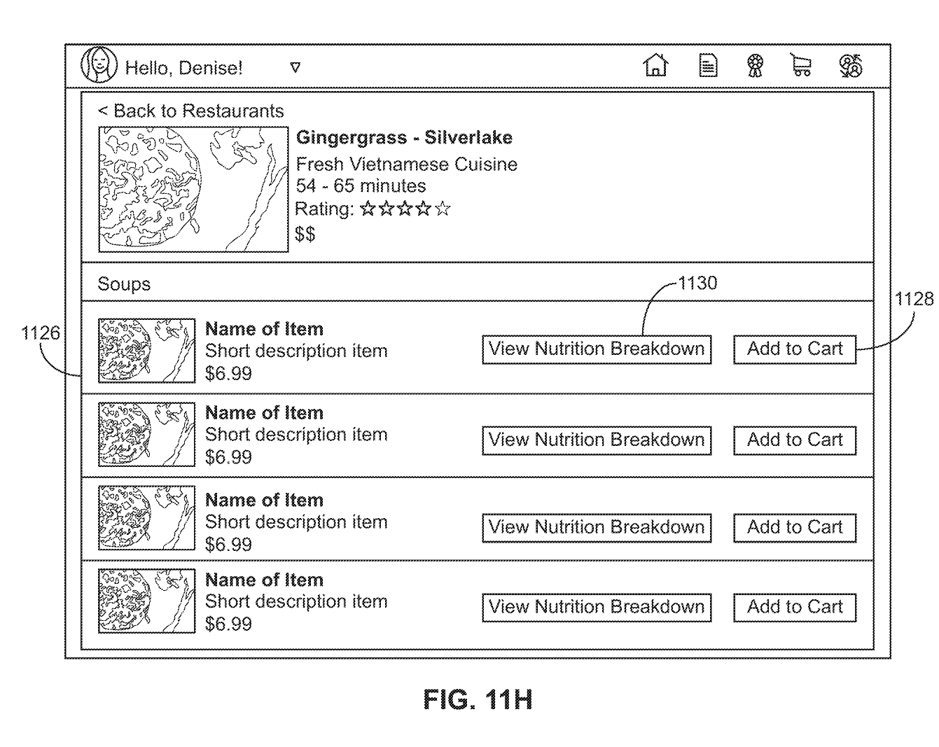

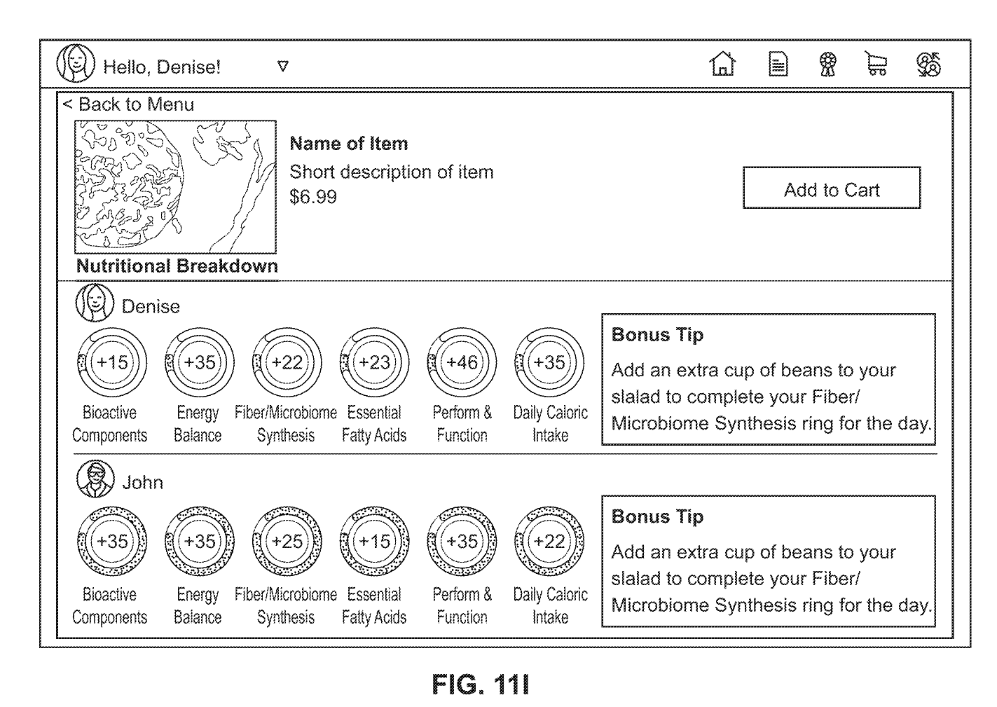

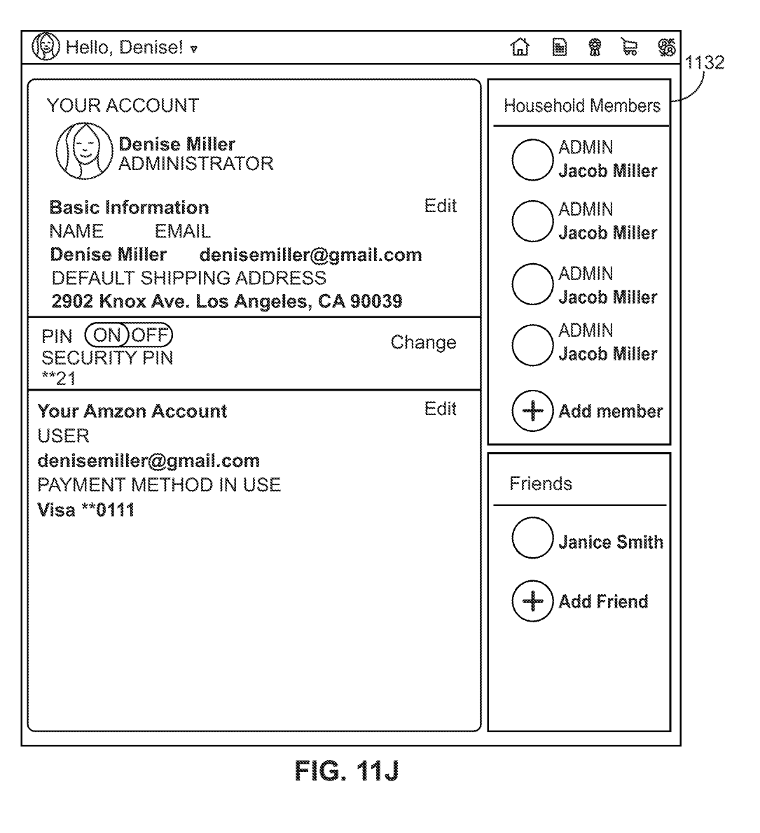

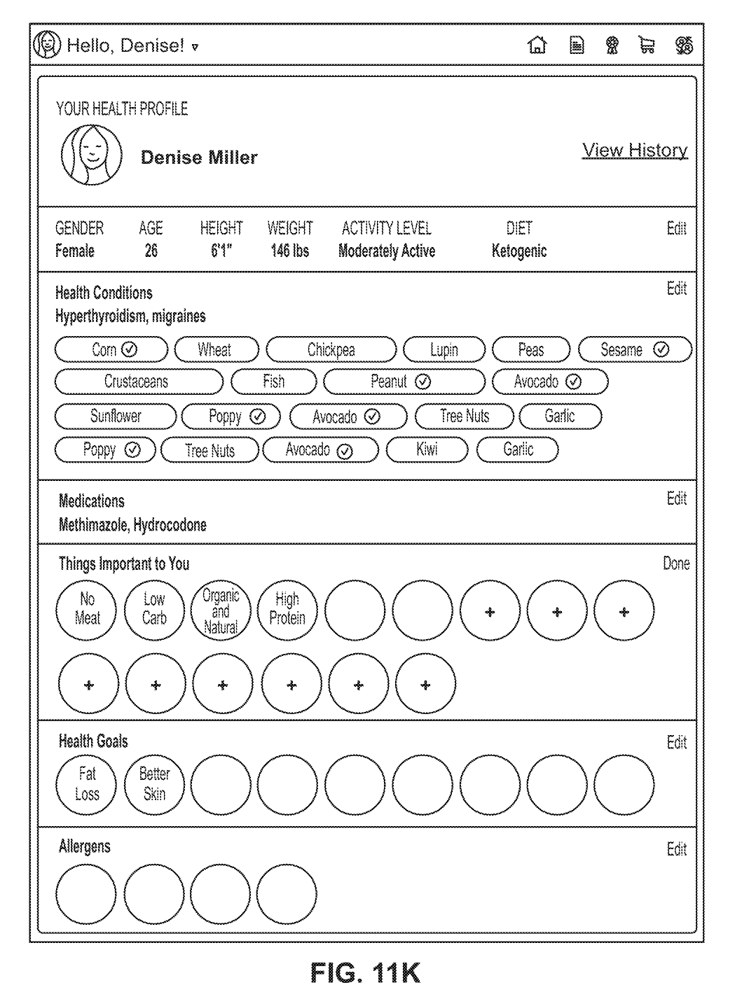

FIGS. 11A-11K illustrate example user interfaces of an application supported by the nutritional application platform 110, according to another embodiment. Specifically, the application shown in FIGS. 11A-11K provides users with nutritional information on various foods, such as those in suggested recipes, take-out orders, consumed foods, and the like. The application can also associate food with the users' emotional or physical state with time links and specific nutrients. The application can also collect users' self-reporting and obtain estimations on which health conditions the user is associated with based on, for example, the recorded self-reports. The application may manage a single user for an account, or may manage multiple users for an account, such as a household of family members, together.

FIG. 11A is an example user interface of a main page of the application supported by the nutritional application platform 110, according to one embodiment. The example user interface in FIG. 11A includes a set 1102 of options for a user to log a consumed food, plan a meal, or order takeout. The user interface also includes a set 1104 of windows that display various metrics for foods that were consumed by the user for a given day. The metrics include scores for bioactive components, energy balance, fiber/microbiome synthesis, essential fatty acids, performance and function, and daily caloric intake. The application may obtain the metrics in conjunction with the food analysis module 422 of the nutritional application platform 110. The user may click into each metric to obtain further details on the breakdown of how the metric was calculated.

FIG. 11B is an example user interface showing a detailed breakdown of the energy balance metric, according to one embodiment. The example user interface includes a window 1108 that describes the meaning of the energy balance metric in more detail, and a set 1106 of windows that display components of the user's food intake that lead to the energy balance metric value. In the example illustration shown in FIG. 11B, the components are ranked according to the user's specific needs and wellness goals. The user may also click into an individual component to obtain further details on the component. For example, the application may display a window that describes the recommended intake of the component, a detailed description of the component, a list of foods that the component can be found in, and a list of recipes that contain the component.

FIG. 11C is an example user interface of a user's food log, according to one embodiment. The page shown in FIG. 11C may be generated responsive to the user clicking on the option “food log” in the set of options 1102 shown in the user interface of FIG. 11A. The example illustration includes a list 1110 of known dishes that the user has consumed over the week. The list 1110 shown in FIG. 11C includes “super salad with golden turmeric dressing,” “cobb salad,” “spinach salad,” “pasta salad,” and “potato salad.” For each item in the list 1110, the application displays a set of metrics that the user can use to determine how each dish affects different aspects of wellness. The set of metrics include scores for bioactive components, energy balance, fiber/microbiome synthesis, essential fatty acids, performance and function, and daily caloric intake. The user can add an item by clicking on an “add” button 1112, or may delete an item by clicking on the “delete” button 1114. Responsive to a user interaction to add a food item to the food log, the application may request the user to enter the date and time of the food intake, the serving size of the meal, and the like.

FIG. 11D is an example user interface for planning a meal, according to one embodiment. The page shown in FIG. 11D may be generated responsive to the user clicking on the option “plan a meal” in the set of options 1102 shown in the user interface of FIG. 11A. The application may request the user to indicate which member of the account will be eating the meal date and time of the meal. Based on the information provided by the user, the application provides the user with a list of suggested recipes. Specifically, the example illustration shown in FIG. 11D includes a list 1116 of suggested recipes for a dinner meal. Each suggested recipe includes a button 1118 that the user can click into to view more details of the recipe.

FIG. 11E is an example user interface showing details of a selected recipe item, according to one embodiment. The example illustration shows details of the selected recipe “super salad with golden turmeric dressing.” The illustration includes a detailed description of the recipe and directions for making the recipe, as well as the different ingredients included in the recipe, along with other types of information. Specifically, the user interface also includes a button 1120 that allows the user to add ingredients to an online shopping cart such that the user can order the ingredients online in a convenient manner. The interface also includes a button 1122 that allows the user to plan the meal of the suggested recipe. In addition, the application may also generate a user interface that allows the user to edit the list of ingredients for the recipe.

FIG. 11F is an example user interface showing the nutritional breakdown of a selected recipe item, according to one embodiment. The page shown in FIG. 11F includes the set of metrics for the selected recipe, similar to types shown in the example of FIG. 11A. Also shown in FIG. 11F, the set of metric values may be different according to the member that will consume the meal due to different health profiles from member to member. For example, the set of metric values for member Denise and the set of metric values for member John are different from each other due to their different health profiles. Similarly to the example of FIG. 11B, the user may click into each metric for an individual member to obtain further details on the breakdown of the metric.

FIG. 11G is an example user interface showing a detailed breakdown of the energy balance metric for an individual member, according to one embodiment. The example illustration in FIG. 11G includes a set 1124 of windows that display the components of the recipe that lead to the energy balance metric value for the user Denise. The components shown in FIG. 11G may also be ranked according to wellness goals of the user.

FIG. 11H is an example user interface for ordering takeout, according to one embodiment. The page of FIG. 11H may be generated responsive to the user clicking on the option “order takeout” in the set of options 1102 shown in the user interface of FIG. 11A. The application may request the user to indicate which member of the account will be ordering the takeout meal, along with other information. Based on the information provided by the user, the application provides the user with a list of food businesses. Each item on the list may be associated with a button that the user can click into to view more details of possible menu items of the business. The example illustration in FIG. 11H shows details of the business “Gingergrass—Silverlake.” The interface includes a list 1126 of menu items available from the business. For each item, the application provides a button 1128 for adding the menu item to an online cart such that the user can conveniently order the takeout meal. The application also provides a button 1130 for viewing the nutritional breakdown of the item.

FIG. 11I is an example user interface showing the nutritional breakdown of a selected menu item, according to one embodiment. The page shows the set of metrics for the selected menu item, similar to the user interface of FIG. 11A. Similarly to FIG. 11F, the set of metric values may be different according to the member that will consume the takeout meal.

FIG. 11J is an example user interface of the account profile of a user, according to one embodiment. As shown in FIG. 11J, the application may request the user to enter account information including profile information, such as name, address, e-mail, and payment information of the user. The application may also request the user to provide a set of members 1132 that are associated with the user, such as the household members of the user.

FIG. 11K is an example user interface of a health profile of a user, according to one embodiment. As shown in FIG. 11K, the application may request the user to enter health profile information that includes various types of health conditions and wellness goals of the user. The application can use the health profile to generate nutritional information specific to the user. In the example illustration in FIG. 11K, the health profile of user “Denise Miller” indicates that the user has a ketogenic diet and other physical characteristics of the user. The health conditions section indicates that the user is associated with health conditions “hyperthyroidism” and “migraines.” Other possible examples that the user may choose from include “arthritis,” “fibromyalgia,” “hypertension,” “depression/anxiety.” The health conditions also indicate that the user is allergic to foods such as corn, sesame, peanuts, avocados, and poppy. Other possible examples that the user may choose from include “wheat,” “chickpeas,” “fish,” “kiwi,” and “garlic.” The medications section indicates that the user is taking “methimazole,” and “hydrocodone.” The things important to you section indicates that the user values no meat, low carbohydrates, organic and natural, and high protein diets. Other possible examples that the user may choose from include no sugar, low cholesterol, low salt, and high fat. The health goals section indicates that the goal of the user is to lose fat and obtain better skin. Other possible examples that the user may choose from include muscle gain, flatter stomach, less pain, and less acne. In addition, the health profile can also indicate foods that user absolutely does not like, how active the user is, and the like. The health profile of the user can be stored in the user information data store 448 in conjunction with the application.

In another instance, the applications 444 include a concussion application that provides nutritional and wellness information to users dealing with acute events such as heart attacks, initial onset of diabetes, or other serious illnesses. The concussion application may be divided into three stages.

The first phase is directed to prevention, general wellness, and performance enhancement. The concussion application provides users with nutritional recommendations that avoid foods that contribute to inflammation, and eating more foods that provide anti-inflammation, anti-cancer, and anti-oxidant biological activities. The concussion application may also allow users to select preferences for avoiding specific diseases or for enhancing performances in athletic or mental capabilities. During the first stage, the concussion application may receive information on the state of a user including existing health information, current nutritional deficiencies, genetics, and health concerns.

The second phase is directed to occurrence of an event to the user that creates an acute treatment phase. The event may be an injury or initial onset of a disease.

The third phase is directed to post-injury with a progressive path to healing and reduction or elimination of symptoms. The concussion application provides a general framework of the requirements for users who are already sick and are using the application to heal themselves, feel better, and reduce prescription medications with their unwanted side effects. Recommendations may be dynamic and can be influenced by time from injury/diagnosis, and updated diagnosis and assessments.

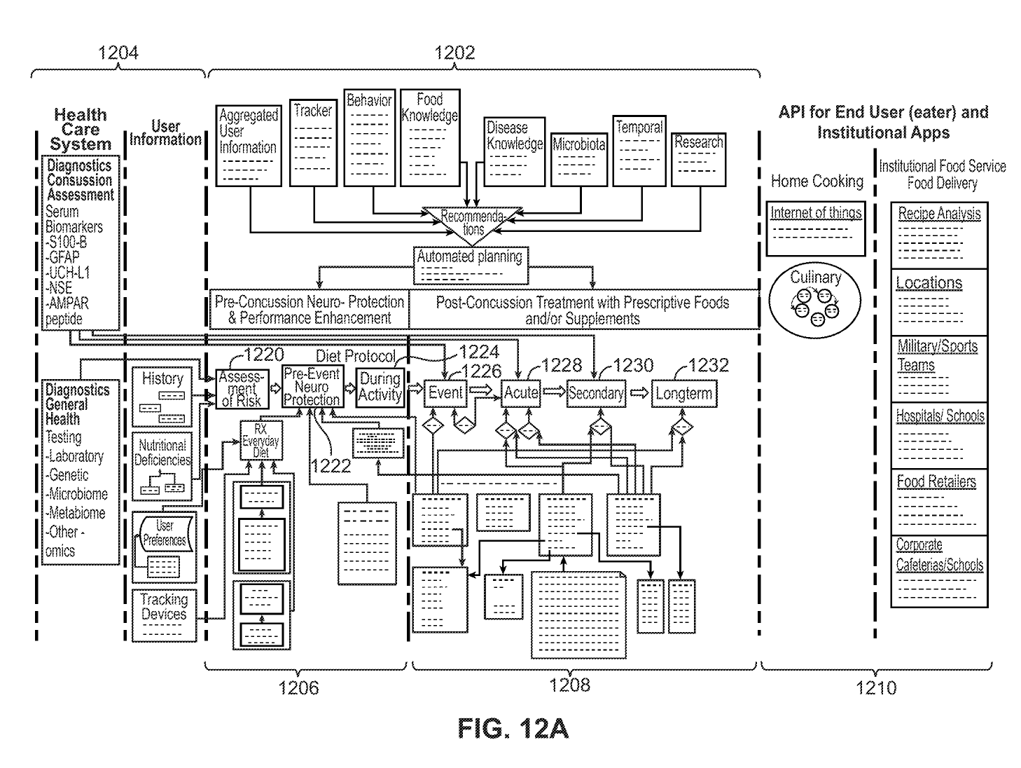

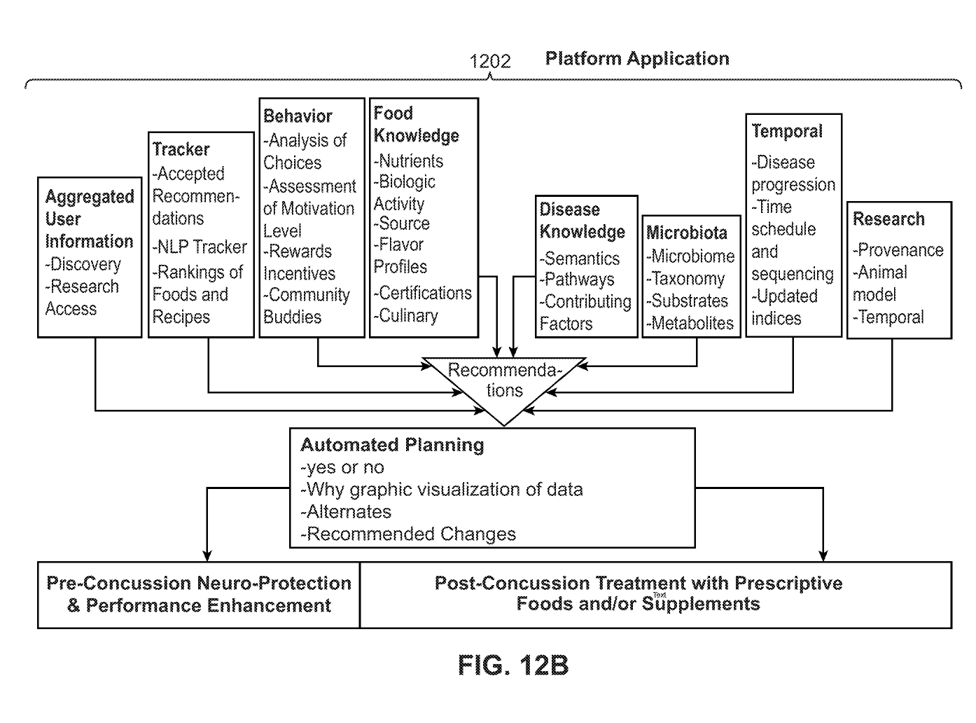

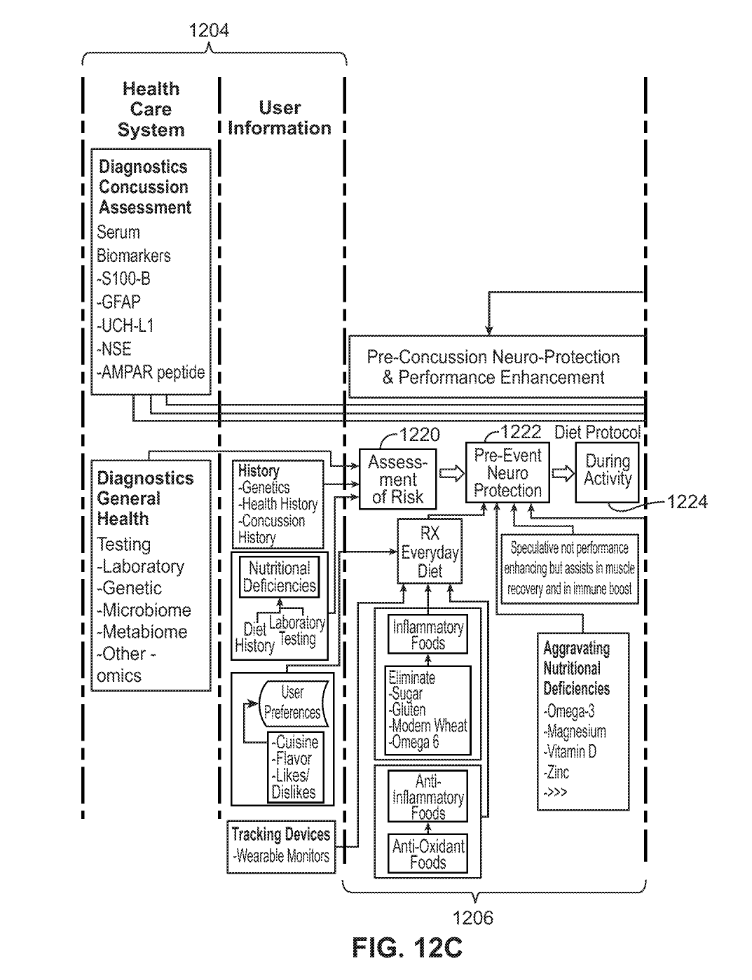

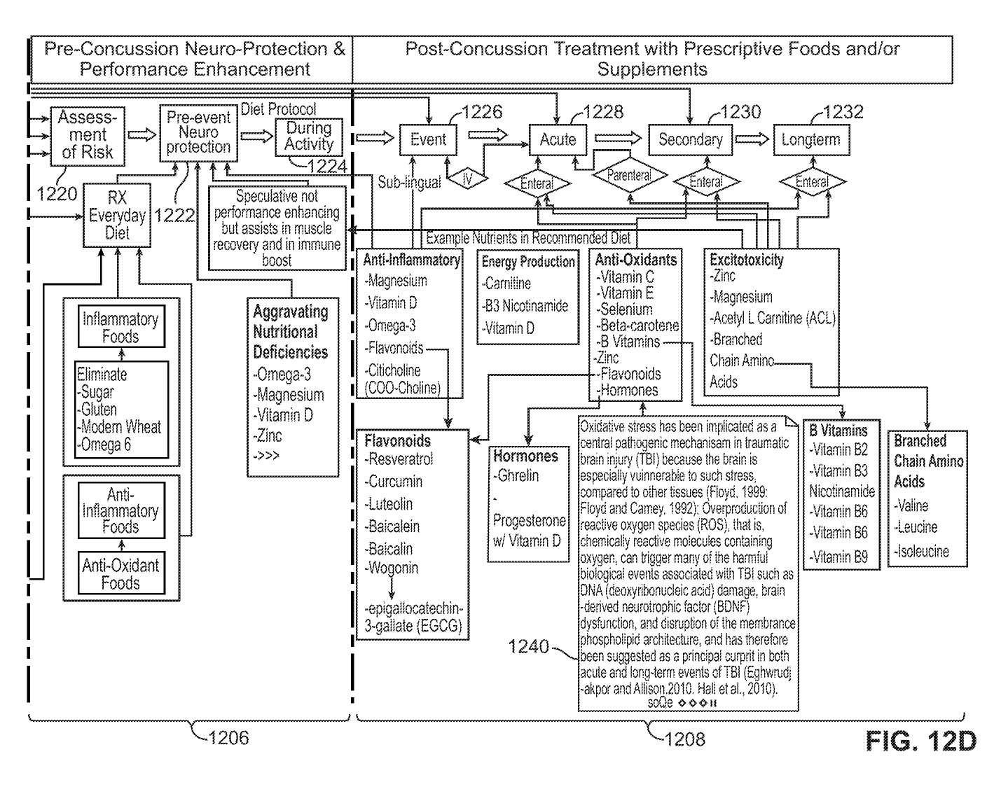

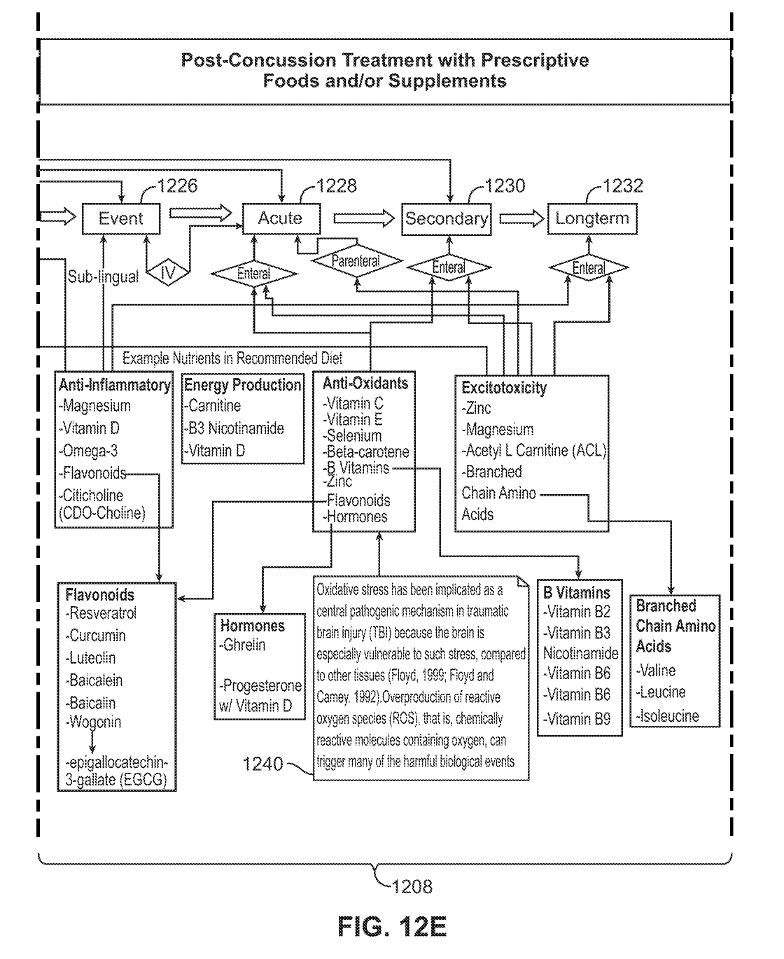

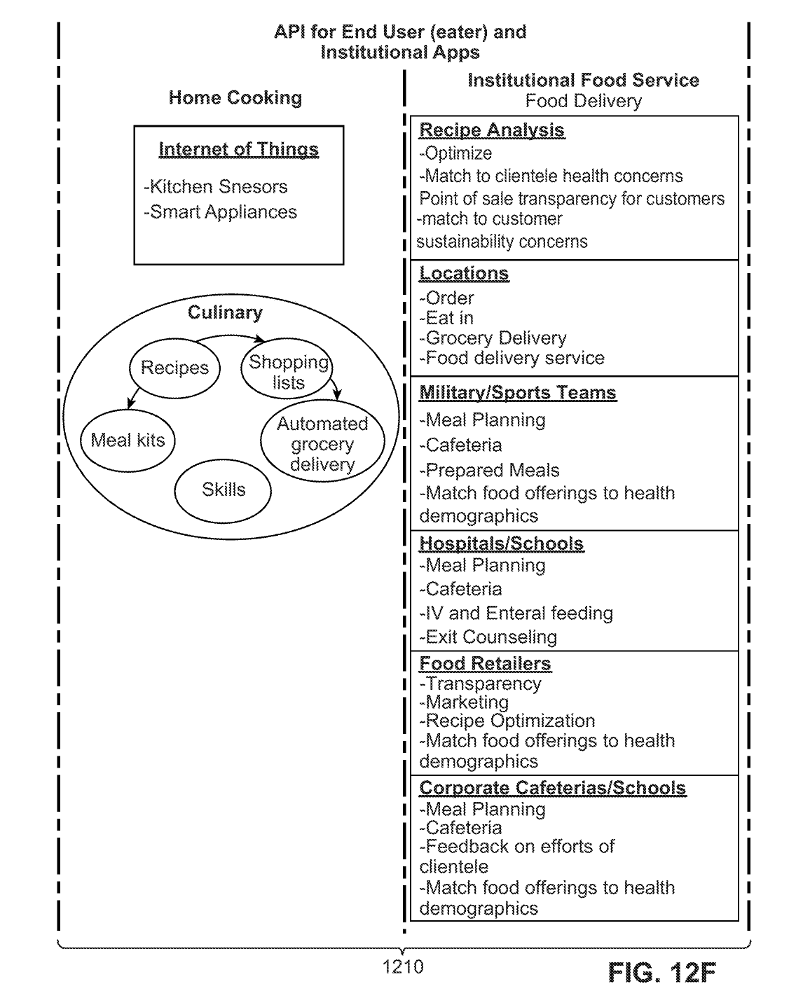

FIG. 12A illustrates an example architecture for a concussion application, according to one embodiment. FIG. 12A shows a platform 1202 for the application, an interface 1204 for receiving information related to users, operation 1206 of the concussion application during the pre-concussion phase, operation 1208 of the concussion application during the post-concussion phase, and API's 1210 to the concussion application that can be accessed by end users. FIG. 12B illustrates a detailed view of the platform 1202 of the concussion application, according to one embodiment. As shown in FIG. 12B, the concussion application incorporates various forms of information to generate recommendations for a user, both during the pre-concussion phase and the post-concussion phase. Specifically, examples can include information from aggregated user information, information from trackers such as accepted recommendations, food trackers, and rankings of foods and recipes, behavioral information of users such as analysis of choices, assessment of motivation level, rewards and incentives, and community members, information from food knowledge such as nutrients, biologic activity, flavor profiles, certifications, and culinary, information from disease knowledge such as semantics, pathways, and other contributing factors, information from microbiota such as microbiome, taxonomy, substrates, and metabolites, temporal information such as disease progression, time schedule and sequencing, and updated indices, and information from research such as provenance, animal models, and temporal aspects of research. These various types of information can be used to recommend foods, nutrients, and the like to the user and also provide automated planning of these nutrients to the user during both the pre-concussion and post-concussion phase.

FIG. 12C illustrates details of user information received by the interface 1204 and operation 1206 of the pre-concussion phase of the concussion application, according to one embodiment. The user information may be stored in the user information data store 448. The concussion application receives information about a user that includes health history, health goals, diet history, information about activity and biometrics from wearables, foods in their refrigerator or on a shopping list, and location (e.g., home cooking or eating out) that affects the nutritional recommendations provided by the application. Health history may include information provided by insurance companies, physicians, and/or diagnostics (e.g., laboratory and -omics). For example, as shown in FIG. 12C, health-related information may include information from serum biomarkers that indicate diagnostics and concussion assessments of the user. The serum biomarkers may include S100 calcium-binding protein B (S100-B), glial fibrillary acidic protein (GFAP), ubiquitin carboxyl-terminal esterase L1 (UCH-L1), neuron specific enolase (NSE), alpha-amino 3-hydroxyl-beta-methyl-4-isoxazolepropionic acid receptor (AMPAR) and peptide. Health-related information may also include information related to general health diagnostics of the user such as laboratory testing, genetic testing, microbiome testing, metabolome testing, and other -omics. The concussion application may take into account the user's culinary and sustainability preferences, and ratings of past meals (e.g., recipes) in the recommendations. Also shown in FIG. 12C are other types of user information including historical information such as genetics history, concussion history, and health history, nutritional deficiencies of the user identified from diet history or laboratory testing, user preferences such as preferences on cuisine, flavor, likes or dislikes of food, and information from tracking devices such as wearable monitors. The behavior modification aspects of the application can use diet history and time from interventions (e.g., rewards, motivational messages, educational/training) to define the level of motivation to align with recommendations (e.g., less-motivated user has simpler and easier tasks).

FIG. 12D illustrates details of operation 1206 of the concussion application during the pre-concussion phase and operation 1208 of the concussion application during the post-concussion phase, according to an embodiment. The concussion application also obtains and combines knowledge from the knowledge database 440 with desired bio-activities. For example, the modules “excitotoxicity,” “anti-inflammatory,” “energy production,” etc. in FIG. 12D can perform these functions. The concussion application may obtain nutrients that provide or prevent these bioactivities from the nutritional application platform 110 to the foods that contain the nutrients or to the products of specific microbiota and the food they consume. As shown in FIG. 12D, nutrients that prevent nutritional deficiencies include omega-3, magnesium, vitamin D, zinc, etc. Nutrients that provide anti-inflammatory effects include magnesium, vitamin D, omega-3, flavonoids, citicholine (CDO-Choline), etc. Nutrients that enhance energy production include carnitine, B3 nicotinamide, vitamin D, etc. Nutrients that provide anti-oxidant effects include vitamin C, vitamin E, selenium, beta carotene, B vitamins, zinc, flavonoids, hormones, etc. Nutrients that prevent excitotoxicity include zinc, magnesium, acetyl L carnitine (ACL), branched chain amino acids, etc. The concussion application may request the identification of such nutrients from components of the nutritional application platform 110. The concussion application may also have access to further details of each nutrient. For example, for the nutrient “flavonoids,” the concussion application may obtain different types of flavonoids such as resveratrol, curcumin, luteolin, baicalein, based on, for example, information contained in the knowledge database 440. As another example, in relation to nutrients that enhance anti-oxidant effects, the concussion application may obtain detailed information 1240 on oxidative stress. As shown in FIG. 12D, the obtained information 1240 indicates that oxidative stress has been implicated as a central pathogenic mechanism in traumatic brain injury (TBI) because the brain is especially vulnerable to such stress, compared to other tissues. Overproduction of reactive oxygen species (ROS), that is, chemically reactive molecules containing oxygen, can trigger many of the harmful biological events associated with TBI such as DNA damage, brain-derived neurotrophic factor (BDNF) dysfunction, and disruption of the membrane phospholipid architecture, and has therefore been suggested as a principal culprit in both acute and long-term events of TBI.

As shown in conjunction with FIGS. 12A, 12C, and 12D, during the pre-concussion phase, the concussion application performs assessment of risk 1220 of a serious health event of the user based on the user's health information as well as historical information and nutritional deficiency information. During a pre-event neuro protection stage 1222, the concussion application may recommend nutrients or foods that contain ingredients for preventing aggravation of nutritional deficiencies, anti-inflammatory effects, and excitotoxicity effects. The concussion application may also suggest recommendations generated by the nutritional application platform 110 for the user that include dietary recommendations based on the user's preferences, information from tracking devices associated with the user, and knowledge from the knowledge database 440. An artificial intelligence (AI) recommender included in the concussion application searches for the best match and optimizes recipes that match the preferences of the user. The recipes could be recipes stored in the nutritional application platform 110, or analyzed from an outside recipe system (e.g., website, food producer, or restaurant). The recommender can also add suggestions to consume a particular food, add particular ingredients to a salad, leave out particular ingredients, and/or replace ingredients with some other combination, and the like.

FIG. 12E illustrates details of operation 1208 of the concussion application during the post-concussion phase, according to an embodiment. As shown in conjunction with FIGS. 12A, 12D, and 12E, during the post-concussion phase, the concussion application detects the presence of a serious health event 1226 of the user based on, for example, health information of the user from concussion assessment diagnostics. Close to the occurrence of an event, the concussion application may recommend nutrients or foods that contain ingredients for preventing anti-inflammatory activities. The recommendation may also indicate that these foods can be consumed in a sublingual manner. The concussion application may detect a start of an acute treatment stage 1228 based on the assessment diagnostics of the user. During the acute treatment stage 1228, the concussion application may recommend nutrients or foods that contain ingredients that enhance anti-oxidant effects and prevents excitotoxicity effects. The recommendation may also indicate that these foods can be consumed in an enteral or parenteral manner. The concussion application may also detect a start of a secondary treatment stage 1230 based on the assessment diagnostics of the user. During the secondary treatment stage 1230, the concussion application may recommend nutrients or foods that contain ingredients that enhance anti-oxidant effects and prevent excitotoxicity effects. The recommendation may indicate that these foods can be consumed in an enteral manner. After the secondary treatment stage 1230, the concussion application may also recommend nutrients and foods for long-term benefit 1232 of the user. Specifically, the concussion application may recommend those that prevent excitotoxicity effects and enhance anti-inflammatory effects.

FIG. 12F illustrates example API's 1210 for clients of the concussion application, according to an embodiment. Specifically, various types of users, either individual consumers or institutional organizations, can access and use the concussion application through, for example, an API. As shown in FIG. 12F, users can be consumers that are cooking at home, or can be institutional organizations such as military/sports teams, hospitals/schools, food retailers, corporate cafeterias, and the like. By using the concussion application, users can design foods and nutritional consumption plans for prevention as well as recovery of serious health events under a comprehensive and easy-to-use framework.

The concussion application can also display a graphic visualization of how the user is progressing. The display can provide feedback at a high level down to a granular measurement of nutritional intake of helpful and unhelpful nutrients with information on what foods contributed to being helpful vs. unhelpful. Indices of progression can include updated testing, changes in prescriptions, and subjective interpretation of symptoms and wellness in a diet diary. A longitudinal analysis of user information, diet history, and changes in health measures may eventually become a source of discovery about previously unknown relationships between food and disease. Rewards can be provided based upon interaction with the system, choices, overall results, etc.

In yet another instance, the applications 444 can include an online learning application for self-education or formal degreed academic programs in biochemical and molecular nutrition. Interactive adaptive courseware modules can be created utilizing the underlying knowledge base as scaffolding for course design. By adding additional functionality for administration, documentation, tracking and reporting a comprehensive Learning Management System (LMS) can be integrated to deliver the knowledge contained in and managed by the nutritional application platform 110. The online learning application can support learning about biochemical and molecular nutrition by navigating the ontology data structures and other databased that span knowledge domains including medicine, biochemistry, nutrition, botany, physiology, pharmacology, cellular biology and others. The underlying graph structure can be traversed via any of the nearly exponential number of semantic paths in conjunction with the navigation module 416, each path corresponding to the exploration of a particular topic. These paths can also be adapted to match the student's current learning abilities. For example, a student focusing on inflammatory disorders could explore a path leading from disorders to different types of anti-inflammatory foods and from there to the biochemistry of constituent nutrients. Alternatively, a student could explore the history of anti-inflammatory cures in ancient China by temporally and geospatially constraining the traversal of the ontology data structures in the knowledge database 440. The courseware application translates the underlying knowledge being traversed along the path into an interactive visual journey through the topic by integrating text, images, videos, and semantic links into a visual presentation.

In yet another instance, the applications 444 may include a medical decision support application for physicians and nutritionists. Such applications combine deep knowledge about disease, signs, symptoms, injuries, pharmaceuticals, treatment protocols, physiology, and cellular biology to help medical professionals make optimized recommendations based on the client or patient's lifestyle, current health, genetics, microbiomes, diet, sleeping patterns, exercise patterns, needs, and goals. Such applications can provide tracking functions for patient progress and re-planning to accommodate deviations from planned diets.

In yet another instance, the applications 444 may include those that aid in pharmaceutical research and drug discovery. Current research in drug discovery from medicinal plants involves a multifaceted approach combining botanical, ethnobotanical, phytochemical, biological, and molecular techniques. Medicinal plant drug discovery continues to provide new and important insights to use against pharmacological targets that include cancer, HIV/AIDS, Ebola, Alzheimer's, malaria, and chronic pain. The database and internal services of the nutritional application platform 110 may integrate many different knowledge domains that contribute to the medicinal plant drug discovery process. A plant with known pharmacological properties can be used as one of many potential entry points to the knowledge base to explore other related species by using taxonomic relationships, physical similarity, geospatial similarity, similar genetics, similar phytochemicals and other perspectives using such applications. These can lead to discovery, for example, of plants with heretofore unknown biochemistry that may have desired pharmacological actions. Alternatively, the drug discovery process could start with obscure ethnobotanical references and enable the user to discover likely plant species using geospatial, chemical, botanical and other clues. One of the primary strengths of the nutritional application platform 110 is that it supports serendipitous discovery of valuable but unexpected knowledge during the medicinal plant drug discovery process. For example, while researching plants with desired pharmacological actions, different plants with the same pharmacological action caused by an entirely unknown new phytochemical may be discovered. These could lead to the discovery of other plant species with highly desirable properties different from the pharmacological intent of the research.

In yet another instance, the applications 444 can include an application that can be used for the research and design of plant-based topical cosmeceuticals at the cellular level using the knowledge database 440. For example, these capabilities can be used to design cosmeceuticals at the molecular level for prevention or treatment of UV damage, aging, or chemical exposure (e.g. airborne or waterborne pollutants) by taking advantage of the semantic links between foods, plants, nutrients and biological pathways stored in the knowledge database 440. The application can be used to employ development of new anti-aging and anti-cancer cosmeceuticals. It can also be used to discover, for example, new plant species with similar properties or genetically engineer entirely new plants with the desired properties. Cosmeceutical discovery applications are quite similar to the medicinal drug discovery applications described previously, with the exception that there is a narrower emphasis on topical formulations typically for hair, nail and skin care. Common products today incorporate nutrients such as retinol, AHA/BHA, vitamins such as C and E, peptides, and liposomes. Plant species, however, have thousands of phytochemicals which have never been researched for such applications. Similar to medicinal drug discovery, there are also deep ethnobotanical references that can be traced back to actual plant species.

In yet another instance, the applications 444 include a military food development application that maintains the health and performance of military personnel who often live and work under some of the most challenging environmental conditions in the world. Current research by the U.S. Army, for example, focuses on high performance military ration components such as PERCs (Performance Enhancing Ration Components) which have demonstrated human performance improvements as great as 15%, and the ERGO (Energy Rich Glucose Optimized) energy drink. The nutritional application platform 110 provides a new knowledge driven environment for the development of new performance ration components based on biochemical and molecular nutrition.

In yet another instance, the applications 444 include an agricultural development and planning application. Plants have valuable pharmacological properties which are derived from their constituent phytochemicals. The concentrations of these phytochemicals can vary substantially based on how the plant is grown—i.e., soil conditions, geospatial location, soil microbiome, precipitation/irrigation, agricultural chemical use. The application can be used to optimize the conditions for production of specific crops or suggest new crops that may have valuable pharmacological uses. Alternatively, the application can be used to optimize the nutrient concentrations in commercially available produce products. In the case of bio-cyclic agriculture, for example, the application can use the knowledge database 440 and the navigation module 416 to derive causal links between soil microbiome, human microbiomes, nutrients and concentrations, and disease etiologies. Such associations can lead to the evolution of entirely new farming paradigms for the optimization of biochemical and molecular nutrition.

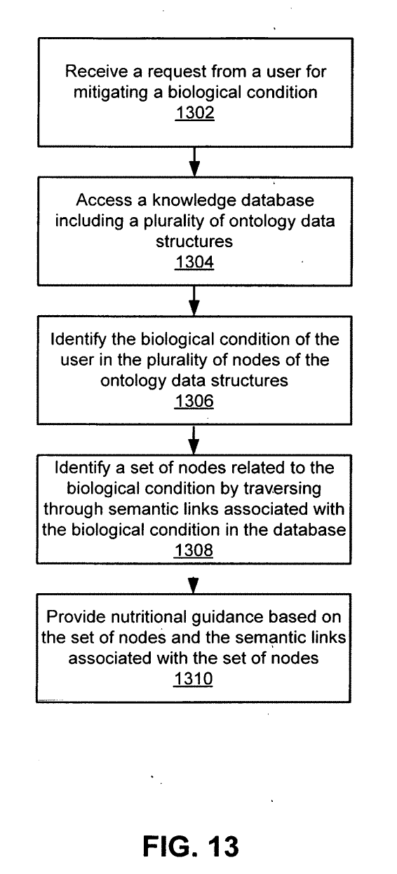

FIG. 13 illustrates a flowchart for providing nutritional guidance to a user, according to an embodiment. The application platform receives 1302 a request for mitigating a biological condition. The request is associated with a user of a client device. The application platform accesses 1304 a knowledge database including a plurality of ontology data structures. The plurality of ontology data structures correspond to a plurality of topics that include at least food, nutrition, and biological conditions. Each ontology data structure includes a plurality of nodes assigned to the topic. The knowledge database includes a plurality of semantic links that each represent a relationship between two nodes. The application platform identifies 1306 the biological condition of the user in the plurality of nodes. The application platform identifies 1308 a set of nodes related to the biological condition of the user by traversing through semantic links associated with the biological condition of the user in the knowledge database. The set of nodes indicate nutritional information associated with the biological condition. The application platform provides 1310 nutritional guidance based on the set of identified nodes and the semantic links associated with the set of nodes.

### CONCLUDING STATEMENTS

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A nutritional application platform, comprising:
an interface configured to receive requests from one or more users for nutritional information associated with wellness goals of the users, the interface further configured to provide the requested nutritional information to the users;
a knowledge database including:
a plurality of ontology data structures corresponding to a plurality of topics, the plurality of topics including at least food, nutrition, and biological conditions, each ontology data structure including a plurality of nodes assigned to the topic, and
a plurality of semantic links, each semantic link representing a relationship type between two nodes;
a set of service components configured to perform one or more decision support services that provide nutrition and health related guidance based on information included in the knowledge database, the set of service components including:
a navigation component configured to manage traversal of the ontology data structures to identify subsets of nodes connected through corresponding subsets of semantic links that are related to the nutritional information requested by the users; and
a semantic middleware component configured to receive the requests and coordinate the set of service components to obtain the requested nutritional information for the requests.

2. The nutritional application platform of claim 1, further comprising an application services component configured to deploy a set of applications that can be executed on one or more client devices to provide nutritional guidance to users, and wherein the requests are received from the set of applications.

3. The nutritional application platform of claim 2, wherein the set of applications includes a nutrient planning application, and wherein the set of service components includes a behavioral planning component configured to receive a set of health-related characteristics of a user from the nutrient planning application and to generate a nutrient consumption plan that adjusts consumption timing of nutrients for the user.

4. The nutritional application platform of claim 3, wherein the behavioral planning component is further configured to:
receive information on an occurrence of an event that causes deviation from the nutrient consumption plan for the user;
responsive to the occurrence of the event, generate a prediction indicating nutritional behavior of the user by applying a machine-learned model to the set of health-related characteristics of the user; and
generate an updated consumption plan based on the prediction.

5. The nutritional application platform of claim 1, wherein the semantic middleware component is further configured to:
receive a search query containing a request to obtain elements related to an element contained in the search query;
based on the search query, determine a degree of similarity between an element of the search query and one or more elements in the knowledge database; and
provide a subset of elements associated with a degree of similarity above a predetermined threshold as a response to the search query.

6. The nutritional application platform of claim 1, further comprising a knowledge discovery component configured to:
access an external database through an external interface of the nutritional application platform;
identify information related to one or more nodes of the plurality of ontology data structures in the external database; and
update the plurality of ontology data structures to incorporate the identified information.

7. The nutritional application platform of claim 6, wherein the knowledge discovery component is further configured to:
obtain a subset of nodes connected through a subset of semantic links;
perform one or more reasoning processes to identify a new relationship between a pair of nodes in the subset of nodes based on the subset of semantic links; and
update the plurality of ontology data structures to incorporate a new semantic link between the pair of nodes that represents the identified relationship.

8. The nutritional application platform of claim 1, wherein the plurality of semantic links include a first subset of semantic links that connect nodes from a same ontology data structure, and a second subset of semantic links that connect nodes from different ontology data structures.

9. The nutritional application platform of claim 1, wherein the relationship type of a semantic link from a first node to a second node indicates that the first node alleviates a condition specified in the second node, the first node causes a phenomenon specified in the second node, the first node aggravates a condition specified in the second node, the first node prevents a condition or action specified in the second node, or an ingredient of the first node is contained in a substance of the second node.

10. The nutritional application platform of claim 1, wherein for each ontology data structure, the corresponding plurality of nodes are organized in a hierarchical structure in which one or more child nodes are organized under corresponding parent nodes based on a taxonomical scientific structure.

11. The nutritional application platform of claim 1, wherein for each ontology data structure, the knowledge database further includes fact instances associated with one or more nodes, the fact instances describing a set of characteristics of the corresponding one or more nodes.

12. A method of providing nutritional guidance to a user, comprising:
receiving requests from one or more users for nutritional information associated with wellness goals of the users;
based on the received request, accessing a knowledge database comprising:
a plurality of ontology data structures corresponding to a plurality of topics, the plurality of topics including at least food, nutrition, and biological conditions, each ontology data structure including a plurality of nodes assigned to the topic, and
a plurality of semantic links, each semantic link representing a relationship type between two nodes in the knowledge database;
obtaining the requested nutritional information by traversing through subsets of nodes in the knowledge database, the subsets of nodes related to the nutritional information requested by the users and connected through corresponding subsets of semantic links; and
providing the obtained nutritional information to the users in response to the requests.

13. The method of claim 12, further comprising deploying a set of applications that can be executed on one or more client devices to provide nutritional guidance to users, and wherein the requests are received from the set of applications.

14. The method of claim 13, wherein the set of applications includes a nutrient planning application, and obtaining the requested nutritional information comprises:
receiving a set of health-related characteristics of a user from the nutrient planning application; and
generating a nutrient consumption plan that adjusts consumption timing of nutrients for the user.

15. The method of claim 14, wherein obtaining the requested nutritional information further comprises:
receiving information on an occurrence of an event that causes deviation from the nutrient consumption plan for the user;
responsive to the occurrence of the event, generating a prediction indicating nutritional behavior of the user by applying a machine-learned model to the set of health-related characteristics of the user; and
generating an updated consumption plan based on the prediction.

16. The method of claim 12, further comprising obtaining:
receiving a search query containing a request to obtain elements related to an element contained in the search query;
based on the search query, determining a degree of similarity between an element of the search query and one or more elements in the knowledge database; and
providing a subset of elements associated with a degree of similarity above a predetermined threshold as a response to the search query.

17. The method of claim 12, further comprising updating the plurality of ontology data structures, the updating comprising:
accessing an external database through an external interface;
identifying information related to one or more nodes of the plurality of ontology data structures in the external database; and
updating the plurality of ontology data structures to incorporate the identified information.

18. The method of claim 17, wherein the updating further comprises:
obtaining a subset of nodes connected through a subset of semantic links from the knowledge database;
performing one or more reasoning processes to identify a new relationship between a pair of nodes in the subset of nodes based on the subset of semantic links; and
updating the plurality of ontology data structures to incorporate a new semantic link between the pair of nodes that represents the identified relationship.

19. The method of claim 12, wherein the plurality of semantic links include a first subset of semantic links that connect nodes from a same ontology data structure, and a second subset of semantic links that connect nodes from different ontology data structures.

20. The method of claim 12, wherein the relationship type of a semantic link from a first node to a second node indicates that the first node alleviates a condition specified in the second node, the first node causes a phenomenon specified in the second node, the first node aggravates a condition specified in the second node, the first node prevents a condition or action specified in the second node, or an ingredient of the first node is contained in a substance of the second node.

21. The method of claim 12, wherein for each ontology data structure, the corresponding plurality of nodes are organized in a hierarchical structure in which one or more child nodes are organized under corresponding parent nodes based on a scientific taxonomic structure.

22. The method of claim 12, wherein for each ontology data structure, the knowledge database further includes fact instances associated with one or more nodes, the fact instances describing a set of characteristics of the corresponding one or more nodes.

23. The method of claim 12, further comprising coordinating a set of service components configured to perform one or more decision support services that provide nutrition and health related guidance based on information included in the knowledge database, the coordinating including coordination of a navigation component that manages the traversing through the subsets of nodes in the knowledge database.
